(19) United States
(12) Patent Application Publication
(10) Pub. No.: US 2026/0212302 A1
(43) Pub. Date: Jul. 23, 2026

(54) FORECASTING ENGINE FOR IDENTIFYING AND MITIGATING SYSTEM ANOMALIES

(71) Applicant: Schneider Electric USA, Inc., Boston, MA (US)

(72) Inventors: Pranshu Tiwari, Grafton, MA (US); Rojiar Haddadian, Revere, MA (US); Chennan Li, Newark, CA (US)

(21) Appl. No.: 19/033,335

(22) Filed: Jan. 21, 2025

(51) Int. Cl. G06Q 10/0637; G06Q 10/067

(52) U.S. Cl. CPC G06Q 10/06375; G06Q 10/067

(57) ABSTRACT

Some aspects provide for techniques for managing waste associated with one or more systems. In some embodiments, the techniques include: obtaining state data for the one or more systems; configuring a forecasting engine to predict future state data for the one or more systems; processing the state data using the configured forecasting engine to predict the future state data; determining, using at least some of the future state data, one or more values indicative of future waste associated with the one or more systems; determining (i) at least one degree of variance between the one or more values indicative of the future waste and one or more values indicative of a target waste specified for the one or more systems, and (ii) a respective confidence associated with the at least one degree of variance; and outputting a report indicating the at least one degree of variance and the respective confidence.

### BACKGROUND

One or more systems can be used to process input(s) to obtain output(s). For example, a mining flotation system can be used to process ore using reagents, water, and energy to obtain recovered minerals as an output. As a result of processing the one or more inputs, the system(s) may generate waste in the form of emissions (e.g., CO₂ emissions, greenhouse gas emissions, etc.) and/or other types of waste. In an effort to monitor and/or control the impact that system(s) have on the environment, a target waste may be established for a particular system or component of the system, and system input(s) may be adjusted such that the generated waste aligns with the target waste.

### SUMMARY

Some aspects provide for a method for managing waste associated with one or more systems used to process one or more inputs to obtain one or more outputs. The method comprises: using at least one processor to perform: obtaining state data for the one or more systems, the state data indicating: (i) a first set of time series for the one or more inputs and (ii) a second set of time series for the one or more outputs; configuring a forecasting engine to predict future state data for the one or more systems, the configuring comprising: selecting at least one forecasting model based on (i) a number of the one or more systems and/or (ii) one or more characteristics of the state data; processing the state data using the configured forecasting engine to predict the future state data for the one or more systems, the future state data indicating: (i) one or more predicted input values for the one or more inputs, and (ii) one or more predicted output values for the one or more outputs; determining, using at least some of the future state data, one or more values indicative of future waste associated with the one or more systems; determining (i) at least one degree of variance between the one or more values indicative of the future waste and one or more values indicative of a target waste specified for the one or more systems, and (ii) a respective confidence associated with the at least one degree of variance; and outputting a report indicating the at least one degree of variance and the respective confidence associated with the at least one degree of variance.

Some aspects provide for a system comprising: at least one processor; and at least one non-transitory computer-readable storage medium storing processor-executable instructions that, when executed by the at least one processor, cause the at least one processor to perform a method for managing waste associated with one or more systems used to process one or more inputs to obtain one or more outputs. The method comprises: obtaining state data for the one or more systems, the state data indicating: (i) a first set of time series for the one or more inputs and (ii) a second set of time series for the one or more outputs; configuring a forecasting engine to predict future state data for the one or more systems, the configuring comprising: selecting at least one forecasting model based on (i) a number of the one or more systems and/or (ii) one or more characteristics of the state data; processing the state data using the configured forecasting engine to predict the future state data for the one or more systems, the future state data indicating: (i) one or more predicted input values for the one or more inputs, and (ii) one or more predicted output values for the one or more outputs; determining, using at least some of the future state data, one or more values indicative of future waste associated with the one or more systems; determining (i) at least one degree of variance between the one or more values indicative of the future waste and one or more values indicative of a target waste specified for the one or more systems, and (ii) a respective confidence associated with the at least one degree of variance; and outputting a report indicating the at least one degree of variance and the respective confidence associated with the at least one degree of variance.

Some aspects provide for at least one non-transitory computer-readable storage medium storing processor-executable instructions that, when executed by at least one processor, cause the at least one processor to perform method for managing waste associated with one or more systems used to process one or more inputs to obtain one or more outputs. The method comprises: obtaining state data for the one or more systems, the state data indicating: (i) a first set of time series for the one or more inputs and (ii) a second set of time series for the one or more outputs; configuring a forecasting engine to predict future state data for the one or more systems, the configuring comprising: selecting at least one forecasting model based on (i) a number of the one or more systems and/or (ii) one or more characteristics of the state data; processing the state data using the configured forecasting engine to predict the future state data for the one or more systems, the future state data indicating: (i) one or more predicted input values for the one or more inputs, and (ii) one or more predicted output values for the one or more outputs; determining, using at least some of the future state data, one or more values indicative of future waste associated with the one or more systems; determining (i) at least one degree of variance between the one or more values indicative of the future waste and one or more values indicative of a target waste specified for the one or more systems, and (ii) a respective confidence associated with the at least one degree of variance; and outputting a report indicating the at least one degree of variance and the respective confidence associated with the at least one degree of variance.

Embodiments of any of the above aspects may have one or more of the following features.

Some embodiments further comprise determining, using the at least one degree of variance, the respective confidence associated with the at least one degree of variance, and/or the future state data, one or more updated values for the one or more inputs.

Some embodiments further comprise outputting a recommendation to use the one or more updated values for the one or more inputs.

Some embodiments further comprise applying the one or more updated values to the one or more inputs and processing the one or more inputs using the one or more systems.

In some embodiments, determining, using the at least one degree of variance and the future state data, the one or more updated values for the one or more inputs comprises: determining whether the at least one degree of variance is greater than or equal to a threshold variance; and after determining that the at least one degree of variance is greater than or equal to the threshold variance, determining the one or more updated values using the future state data.

In some embodiments, selecting the at least one forecasting model comprises selecting the at least one forecasting model from among: at least one multivariate forecasting model, at least one univariate forecasting model, and dynamic mode decomposition.

In some embodiments, selecting the at least one forecasting model based on the number of the one or more systems comprises selecting dynamic mode decomposition when the number of the one or more systems is greater than one.

In some embodiments, selecting the at least one forecasting model based on the number of the one or more systems comprises selecting the at least one multivariate forecasting model or the at least one univariate forecasting model when the number of the one or more systems is equal to one.

In some embodiments, configuring the forecasting engine further comprises: obtaining training data for the one or more systems; and processing the training data using temporal clustering to identify one or more characteristics of the training data. In some embodiments, selecting the at least one forecasting model based on the one or more characteristics of the state data comprises: selecting at least one multivariate forecasting model, from among a plurality of multivariate forecasting models, based on the one or more characteristics of the training data.

In some embodiments, the plurality of multivariate forecasting models comprises a vector autoregressive (VAR) model, a recurrent neural network (RNN) model, decision tree model, and an autoregressive moving average (ARMA) model.

In some embodiments, processing the training data using temporal clustering comprises processing the training data using Euclidean distance temporal clustering, shape-based temporal clustering, or dynamic time warping.

In some embodiments, the one or more characteristics of the training data comprise a degree of correlation among time series, a non-linear relationship among the time series, an amount of data in the time series, and/or a degree of noise present in the time series.

In some embodiments, configuring the forecasting engine further comprises: obtaining training data for the one or more systems; and identifying one or more characteristics of the training data. In some embodiments, selecting the at least one forecasting model based on the one or more characteristics of the state data comprises: selecting at least one univariate forecasting model, using the one or more characteristics of the training data, from among a vector autoregressive (VAR) model, a recurrent neural network (RNN) model, and an autoregressive moving average model (ARMA).

In some embodiments, the one or more characteristics of the training data comprise an amount of data in time series and/or a degree of noise in the time series.

In some embodiments, obtaining the state data comprises obtaining at least some of the first set of time series and/or at least some of the second set of time series using one or more sensors.

In some embodiments, the first set of time series and/or the second set of time series were previously obtained during a time interval having a duration between two and twenty hours, between three and fifteen hours, or between four and ten hours.

In some embodiments, a system of the one or more systems comprises a plurality of components. In some embodiments, the one or more inputs comprise a respective input for each of the plurality of components. In some embodiments, determining the one or more values indicative of the future waste associated with the one or more systems comprises determining one or more values indicative of future waste associated with a particular component of the plurality of components. In some embodiments, determining the at least one degree of variance comprises determining, for the particular component, a degree of variance between the one or more values indicative of the future waste associated with the particular component and one or more values indicative of a target waste associated with the particular component.

Some embodiments further comprise determining using the degree of variance for the particular component, an updated value for the respective input for the particular component.

Some embodiments further comprise: representing the one or more systems as a graph comprising nodes and edges, wherein a node represents a system or a component of the system, and wherein the edges represents connections between the nodes; dividing the graph into a plurality of sub-graphs; and identifying, using the at least one degree of variance, one or more of the plurality of sub-graphs associated with a degree of variance that is greater than or equal to a threshold.

In some embodiments, the one or more systems comprise a nickel and mining flotation system, the one or more inputs comprise energy consumption, water consumption, a respective type of one or more reagents, and/or a respective amount of the one or more reagents, the one or more outputs comprise a grade of recovered nickel, a grade of recovered copper, emissions data, and/or an amount of tailings, and the method further comprises: outputting a recommendation to update the respective type of the one or more reagents and/or the respective amount of the one or more reagents.

In some embodiments, the one or more systems comprise a water desalination system, the one or more inputs comprise a salinity level of source water, total dissolved solids in the source water, presence of contaminants in the source water, a flow rate of source water intake, one or more pressure levels in the water desalination system, energy consumption by one or more pumps and/or membranes, an amount of one or more antiscalants, a type of one or more antiscalants, a type of one or more chemicals, temperature of the source water, salinity variations of the source water, one or more seasonal factors, one or more energy sources, and/or one or more climatic factors, the one or more outputs comprise a volume of freshwater produced and/or a concentration of salts and contaminants in the freshwater produced, and the method further comprises: outputting a recommendation to update the flow rate of the source water intake, the one or more pressure levels, and/or the energy consumption by the one or more pumps and/or membranes.

In some embodiments, the one or more systems comprise a butter churning system, the one or more inputs comprise an amount of cream, a temperature, a churn speed, a churn time, and/or energy consumption, the one or more outputs comprise an amount of butter, an amount of buttermilk, an amount of waste byproducts, moisture content of the butter, and/or a fat-free dry matter of the butter, and the method further comprises: outputting a recommendation to update the churn time, the churn speed, the temperature, and/or the energy consumption.

In some embodiments, processing the state data using the configured forecasting engine to predict the future state data for the one or more systems comprises processing the state data in near real time.

### BRIEF DESCRIPTION OF DRAWINGS

Various aspects and embodiments of the disclosure provided herein are described below with reference to the following figures. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A, FIG. 1B, and FIG. 1C are diagrams of illustrative techniques for managing waste associated with one or more systems, according to some embodiments of the technology described herein.

FIG. 2A is a diagram of an example system having a plurality of components, according to some embodiments of the technology described herein.

FIG. 2B is a diagram of an example collection of systems, according to some embodiments of the technology described herein.

FIG. 3 is a block diagram of an example system for managing waste associated with one or more systems, according to some embodiments of the technology described herein.

FIG. 4 is a flowchart of an illustrative process 400 for managing waste associated with one or more systems, according to some embodiments of the technology described herein.

FIG. 5 is an example heatmap indicating components of a system for which future waste is predicted to vary from a target waste specified for those components, according to some embodiments of the technology described herein.

FIG. 6A, FIG. 6B, and FIG. 6C are diagrams of example gates of a long short-term memory (LSTM) recurrent neural network (RNN), according to some embodiments of the technology described herein.

FIG. 7A and FIG. 7B show a diagram of an example nickel and mining flotation system, according to some embodiments of the technology described herein.

FIG. 8 is a schematic diagram of an illustrative computing device with which aspects described herein may be implemented.

### DETAILED DESCRIPTION

A system or collection of systems can be used to process input(s) to obtain output(s). The processing of the input(s) may result in waste in the form of emissions (e.g., CO₂ emissions, greenhouse gas emissions, etc.) and/or other types of waste. Waste produced by the system(s) may be compared to a target waste specified for the system(s) and/or particular component(s) of the system(s). One or more anomalies in the system(s) may result in variance(s) between the waste produced by the system(s) and the target waste specified for the system(s).

The inventors have developed techniques that improve the identification of anomalies in system(s). In some embodiments, the techniques involve using a forecasting engine to predict future state data (e.g., future inputs and/or outputs) for the system(s), and using the future state data to predict the future waste likely to be generated by the system(s). In some embodiments, the techniques additionally include determining (i) at least one degree of variance between the predicted future waste and a target waste specified for the system(s), and (ii) optionally, a confidence in the at least one degree of variance. The degree(s) of variance and confidence therein may be used to identify potential anomalies in the system(s), which may then be leveraged to mitigate the predicted variances (e.g., by adjusting input(s) of the system(s)).

The inventors have further recognized that, while a forecasting engine is used for the identification of anomalies in system(s), conventional techniques for configuring a forecasting engine can be improved upon. In particular, the conventional approach for configuring a forecasting engine for a particular system or collection of systems is extremely time consuming because a data scientist has to meticulously study large quantities of data, select a model or multiple models, train the selected models, set model parameters, and evaluate model performance for each system or collection of systems. This process is further complicated and made inefficient by the complexity of different systems (e.g., how system components are connected to and interrelate with one another) that should be accounted for when configuring the forecasting engine. Not only is the conventional approach for configuring a forecasting engine inefficient, but in practice it also likely precludes the deployment of the configuring approach whatsoever given the lack of availability of time and resources to perform the configuring.

Accordingly, the inventors have further developed improved techniques for automatically configuring a forecasting engine that address the above-described challenges and inefficiencies associated with the conventional techniques for configuring a forecasting engine. In some embodiments, the techniques include configuring a forecasting engine to predict future state data for one or more systems at least in part by selecting at least one forecasting model based on (i) a number of systems included in the system or collection of systems, and/or (ii) one or more characteristics of the state data (e.g., input and/or output values) obtained for the system or collection of systems. The techniques developed by the inventors automatically and efficiently account for complexities and characteristics of the particular system(s) for which the forecasting engine is being configured by considering the number of systems and past data (e.g., the state data) for the system(s).

Following below are descriptions of various concepts related to, and embodiments of, techniques for configuring and using a forecasting engine to identify anomalies in one or more systems. It should be appreciated that various aspects described herein may be implemented in any of numerous ways, as the techniques are not limited in any particular manner of implementation. Example details of implementations are provided herein solely for illustrative purposes. Furthermore, the techniques disclosed herein may be used individually or in any suitable combination, as aspects of the technology described herein are not limited to the use of any particular technique or combination of techniques.

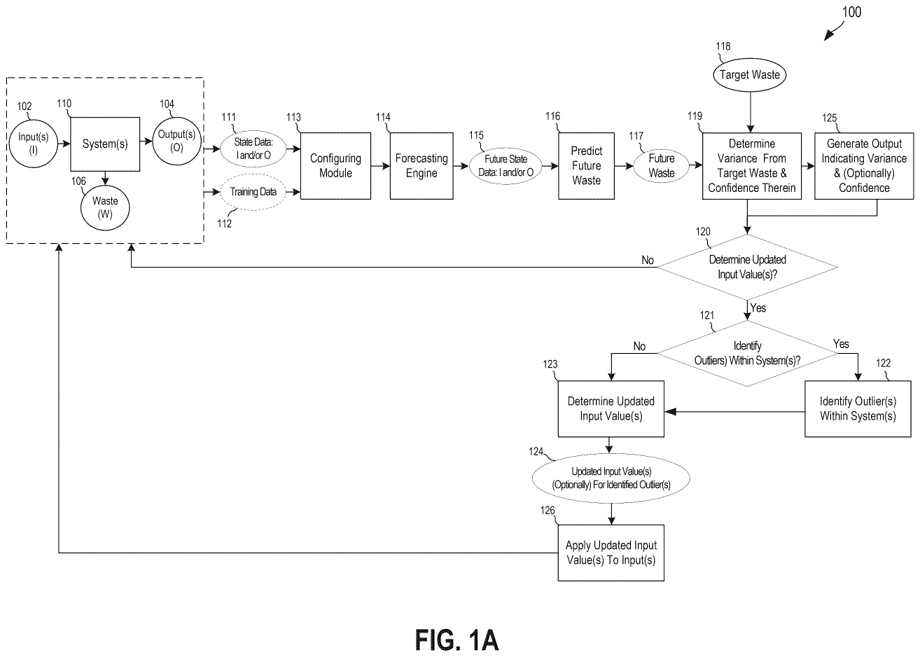

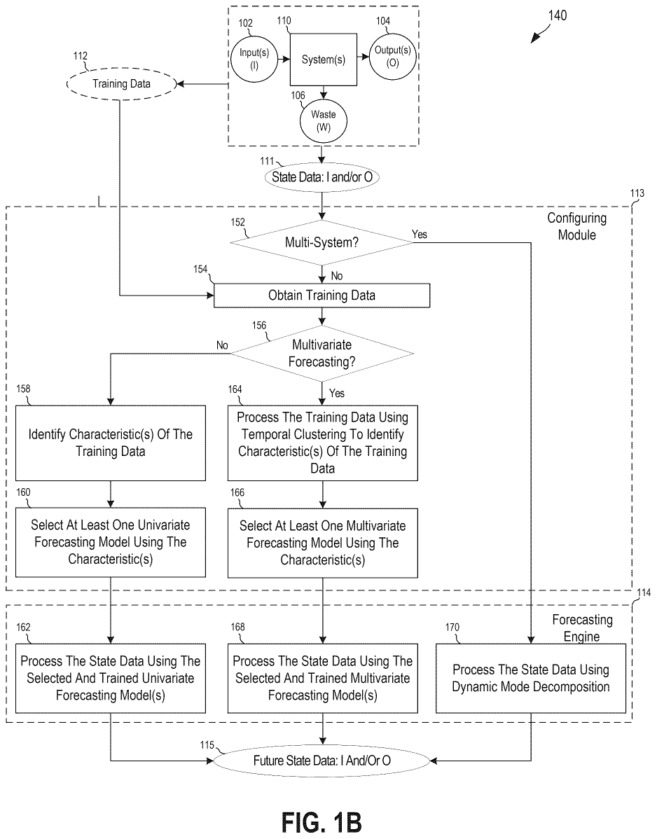

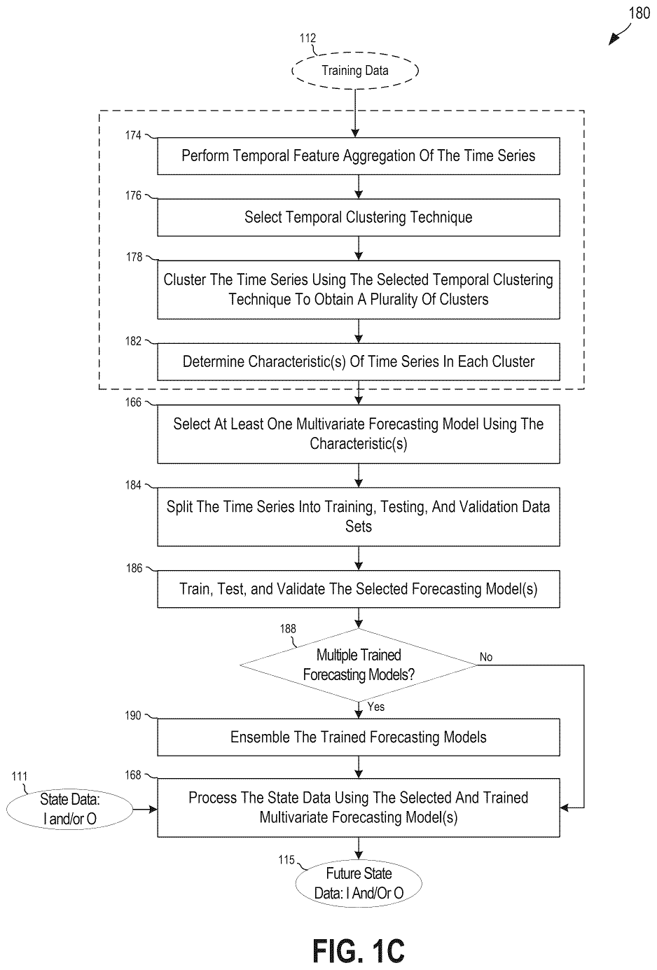

FIG. 1A is a diagram depicting an illustrative technique 100 for managing waste associated with one or more systems 110, according to some embodiments of the technology described herein. As shown in FIG. 1A, in some embodiments, the technique 100 involves determining, at act 119, at least one degree of variance between future waste 117 predicted for the system(s) 110 and target waste 118 specified for the system(s) and a respective confidence in the at least one degree of variance. The degree(s) of variance and confidence therein can be used to make decisions about whether and how to update input(s) 102 to system(s) 110 to modify the waste 106 and/or output(s) 104 of the system(s) 310. For example, one or more input values may be updated (e.g., to obtain updated input value(s) 124) and applied to input(s) 102 (e.g., at act 126) to reduce the waste 106 or increase a quantity or quality of the output(s) 104.

In some embodiments, the system(s) 110 are configured to process or operate on one or more inputs 102 to obtain one or more outputs 104. For example, the system(s) 110 may include one or more machines, devices, and/or physical processing steps used to process the one or more inputs 102 to obtain the one or more outputs 104. Examples of systems include a nickel and copper mining flotation system, a butter churning system, and a water desalination system. The nickel and copper mining flotation system may be configured to process ore, as an input, to recover nickel and copper as outputs. The butter churning system may be configured to process cream, as an input, to obtain butter and/or buttermilk as an output. The water desalination system may be configured to process saltwater, as an input, to obtain fresh water as an output. The example systems are described herein in more detail, including at least in the section entitled “Examples.”

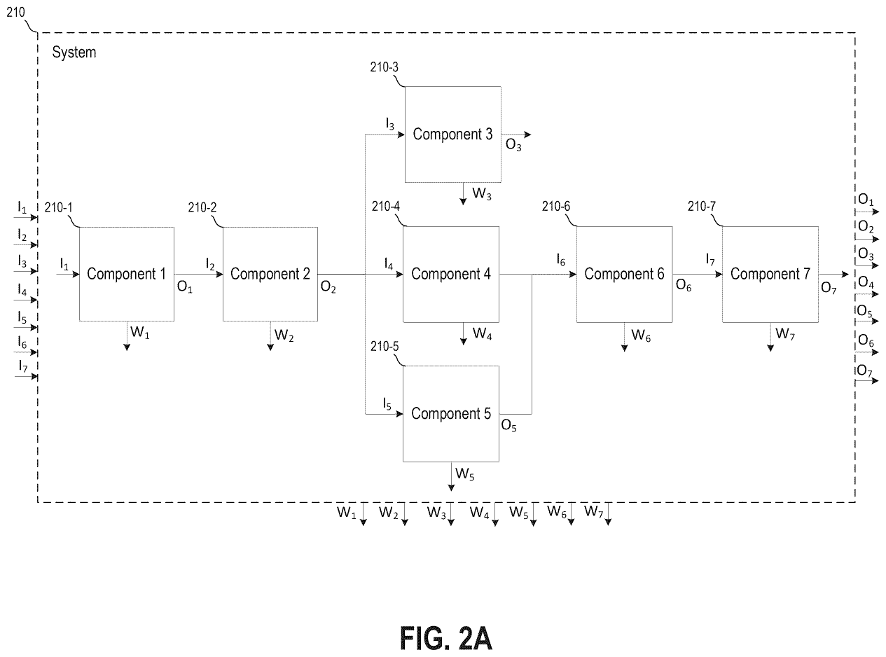

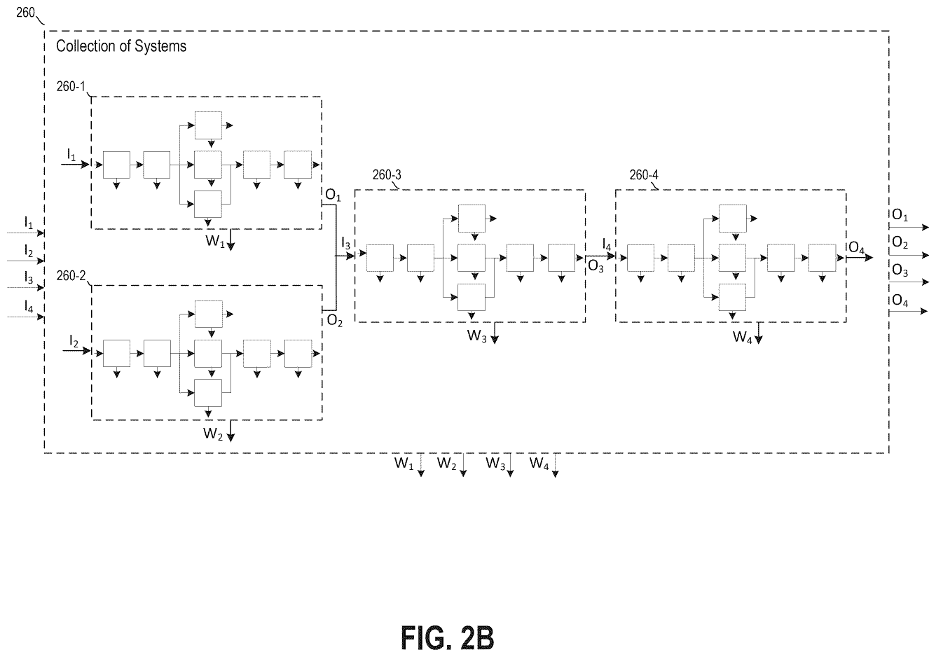

The system(s) 110 may be a single system or a collection of multiple systems. An example of a single system 210 is shown in FIG. 2A, and an example of a collection of systems 260 is shown in FIG. 2B. As shown in FIG. 2A, a system 210 may include multiple components (e.g., components 210-1, 210-2, 210-3, 210-4, 210-5, 210-6, 210-7, etc.). A component of the system 210 may represent a sub-process or stage of the processing performed by the system 210. For example, in the context of the nickel and copper mining flotation system, one component (e.g., component 210-1) of the system may represent a grinding stage, another component (e.g., component 210-2) of the system may represent a combined rougher stage, and so on. In some embodiments, an individual component of the system 210 has respective input(s), output(s), and waste. For example, component 210-1 has input(s) I₁, output(s) O₁, and waste W₁. In some embodiments, one or more outputs of a particular component may be provided as input to another component in the system 210. For example, one or more of the output(s) 01 are provided as input(s) I₂ to component 210-2. The respective input(s), output(s), and waste of the various components of the system 210 may be aggregated to define the inputs, outputs, and waste of the system 210 as a whole.

As shown in FIG. 2B, a collection of systems 260 may include multiple systems (e.g., systems 260-1, 260-2, 260-3, and 260-4), each of which may include one or more respective components. In some embodiments, an individual system of the collection of systems has respective input(s), output(s), and waste. For example, system 260-1 has input(s) I₁, output(s) O₁, and waste W₁, which may represent the aggregation of the input(s), output(s), and waste of individual components of the system 260-1. In some embodiments, the systems 260 are connected in that one or more outputs of one system may be provided as input(s) to another. For example, as shown in FIG. 2B, system 260-1 and system 260-3 are connected because one or more of the outputs 01 of system 260-1 may be provided as inputs I₃ to system 260-3. The respective input(s), output(s), and waste of the various systems may be aggregated to define the inputs, outputs, and waste of the collection of systems 260 as a whole.

Referring again to FIG. 1A, in some embodiments, the one or more inputs 102 include starting material(s) (e.g., raw or pre-processed materials) that are transformed, by processing the starting material(s) using the system(s) 110, to obtain the output(s) 104. For example, in the context of a nickel and copper mining flotation system, ore may be provided to the system as the starting material that is processed to obtain nickel and copper. In the context of a butter churning system, cream may be provided to the system as the starting material that is processed to obtain butter and/or buttermilk. In the context of a water desalination system, saltwater may be provided to the system as the starting material that is processed to obtain fresh water.

The one or more inputs 102 may additionally include inputs that are applied to the starting material(s) to obtain the output(s) 104. For example, inputs that are applied to the starting material(s) may include one or more other materials, operational parameters, energy, one or more environmental conditions, and/or any other suitable inputs that are applicable to the particular system(s), as aspects of the technology described herein are not limited in this respect. Examples of types of materials that may be applied to starting material(s) include water and/or chemical reagents, among others. The input materials may vary in type and amount. Examples of operational parameters include flow rates, pressure levels, processing durations, churn speeds, and/or air flow, among others. Examples of environmental conditions include temperature, humidity, seasonal factors, and/or climatic factors, among others.

In some embodiments, the one or more outputs 104 include product(s) resulting from processing the input(s) 102. For example, in the context of a nickel and copper mining flotation system, nickel and copper may be products that result from processing ore. In the context of the butter churning system, butter and/or buttermilk may be the product(s) resulting from processing cream. In the context of the water desalination system, freshwater may be the product resulting from processing saltwater.

In some embodiments, the one or more outputs 104 include an indication of amount and/or one or more qualities of the resulting product(s). For example, in the context of a nickel and copper mining flotation system, the output(s) 104 may include an indication of recovery rates of nickel and/or copper. Additionally or alternatively, the output(s) 104 may include an indication of the grades of the nickel and/or copper recovered. In the context of a butter churning system, the output(s) 104 may include an indication of the moisture content and/or fat-free dry matter (FFDM) of the resulting butter. In the context of a water desalination system, the output(s) 104 may include an indication of a volume of freshwater produced and/or a concentration of salts and/or contaminants in the freshwater produced.

In some embodiments, while processing the input(s) 102 to obtain the output(s) 104, the system(s) 110 may generate waste 106. The waste 106 may include one or more metrics that represent respective types of waste. For example, the waste 106 may include one or more metrics that represent a respective one or more types of emissions (e.g., CO₂, other greenhouse gases, etc.). Additionally or alternatively, the waste 106 may include one or more metrics that represent one or more quantities of material(s) other than the desired products that are output by system(s) 110. Additionally or alternatively, the waste 106 may include metric(s) representing any other suitable type of waste, as aspects of the technology described herein are not limited in this respect. For example, in the context of a nickel and copper mining flotation system, the waste 106 may include a metric indicating an amount of tailings (e.g., materials left over after nickel and copper are extracted) output. In the context of a water desalination system, the waste 106 may include metric(s) indicating a volume and/or concentration of brine output. In the context of a butter churning system, the waste 106 may include a metric indicating an amount of butter having a moisture level that is greater than or equal to a specified moisture level and/or an amount of butter having a percentage of fat-free dry matter that is outside of a specified range.

As shown in FIG. 1A, state data 111 is obtained for system(s) 110. In some embodiments, state data represents recent system input and/or output data that can be used to forecast future input and/or output data for the system. For example, in some embodiments, the state data 111 includes a first set of time series for one or more (e.g., all) of the input(s) 102. The first set of time series may include a single time series for a single input, or multiple time series for multiple inputs. The first set of time series may include time series for one or more (e.g., all) components of system(s) 110 and/or for one or more (e.g., all) systems of system(s) 110. A time series for a particular input may represent value(s) of the particular input provided to the system(s) 110 at one or more time points over a period of time. For example, given temperature as an input, the state data 111 may include a time series that indicates the measured temperature at one or more time points during the period of time. The time period may be of any suitable duration, as aspects of the technology described herein are not limited in this respect. For example, the duration of the time period may be a duration between 5 minutes and 120 hours, between 30 minutes and 96 hours, between 1 hour and 72 hours, between 2 hours and 48 hours, between 3 hours and 24 hours, between 4 hours and 10 hours, or a duration within any other suitable range of hours, as aspects of the technology described herein are not limited in this respect. In some embodiments, the time series value(s) are obtained at periodic or aperiodic time points during the time period.

In some embodiments, the state data 111 additionally or alternatively includes a second set of time series for one or more (e.g., all) of the output(s). The second set of time series may include a single time series for a single output or multiple time series for multiple outputs. The second set of time series may include time series for one or more (e.g., all) components of system(s) 110 and/or for one or more (e.g., all) systems of system(s) 110. A time series for a particular output may represent value(s) of the particular output at one or more time points over a period of time. For example, given freshwater as an output of a water desalination system, the state data 111 may include a time series that indicates the volume of freshwater output by system(s) 110 at one or more time points during the time period. The time period may be of any suitable duration, as aspects of the technology described herein are not limited in this respect. For example, the duration of the time period may be a duration between 5 minutes and 120 hours, between 30 minutes and 96 hours, between 1 hour and 72 hours, between 2 hours and 48 hours, between 3 hours and 24 hours, between 4 hours and 10 hours, or a duration within any other suitable range of hours, as aspects of the technology described herein are not limited in this respect. In some embodiments, the time series value(s) are obtained at periodic or aperiodic time points during the time period.

In some embodiments, training data 112 is optionally obtained for system(s) 110. The training data 112 may represent past trends in the system input(s) 102 and/or output(s) 104. Thus, in some embodiments, the training data 112 includes one or more time series for one or more of the input(s) 102 and/or one or more of the output(s) 104. A time series included in the training data 112 may represent value(s) obtained for a particular input or output during a time period preceding or overlapping with the time period(s) for which the state data 111 was obtained.

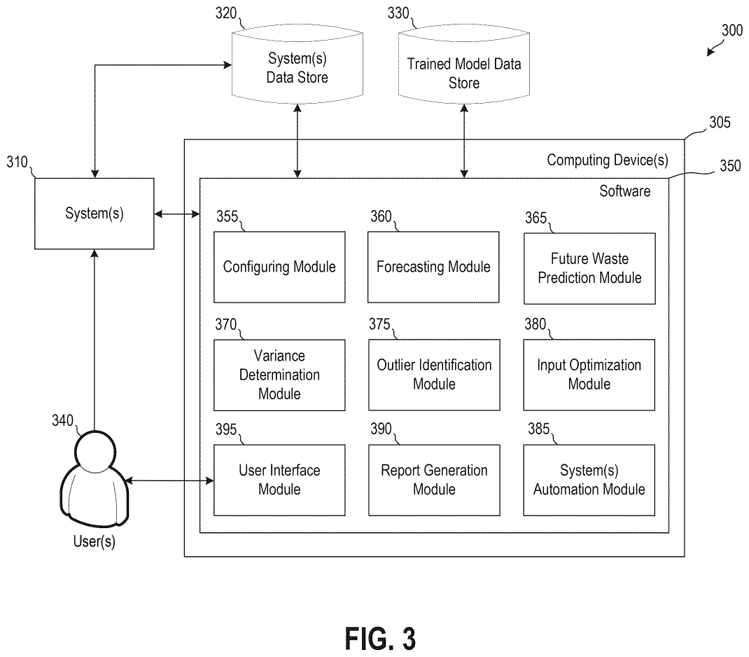

In some embodiments, the state data 111 and/or the training data 112 is obtained by one or more computing device(s) (e.g., computing device(s) 305 shown in FIG. 3) used to perform one or more function(s) described herein in more detail. For example, the state data 111 and/or training data 112 may be obtained directly or indirectly from sensor(s) and/or other device(s) used to measure same. For example, the sensor(s) and/or other device(s) may be part of system(s) 110. Additionally or alternatively, the state data 111 and/or training data 112 may be obtained directly or indirectly from one or more user(s). For example, the user(s) may provide an indication of the state data 111 and/or training data 112 as input to the computing device(s) via a user interface of the computing device(s) and/or by uploading the state data 111 and/or training data 112. Additionally or alternatively, the computing device(s) may obtain the state data 111 and/or training data 112 from one or more data stores.

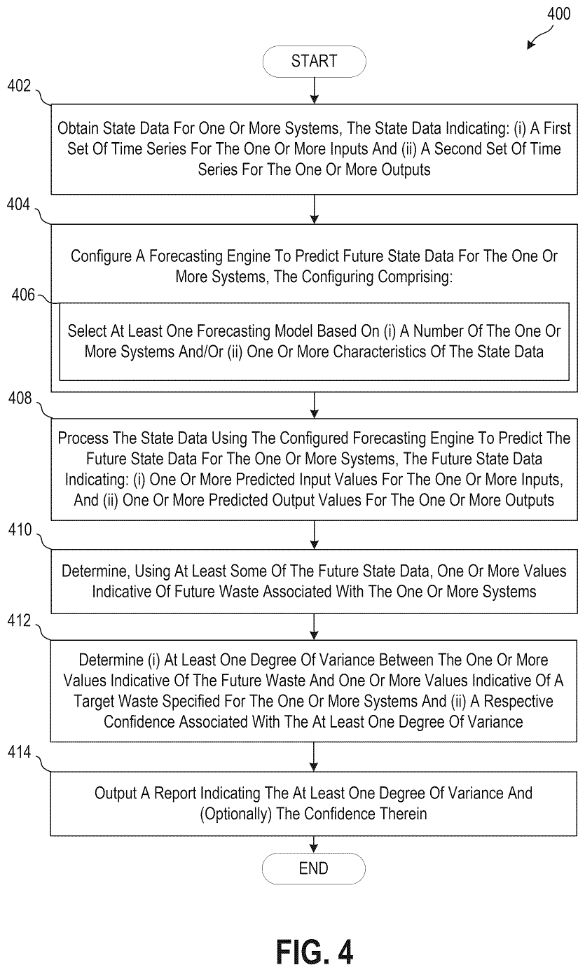

As shown in FIG. 1A, the state data 111 and (optionally) the training data 112 is used by configuring module 113 to configure the forecasting engine 114. In some embodiments, as part of configuring the forecasting engine, the configuring module 113 may select at least one forecasting model from among dynamic mode decomposition, a univariate forecasting model, and a multivariate forecasting model. The selection may be based on (i) a number of the system(s) 110, and/or (ii) characteristic(s) of state data 111 and/or training data 112 obtained for the system(s) 110. In some embodiments, the configuring module 113 is further configured to train the selected forecasting model(s) using training data 112. Example techniques for configuring a forecasting engine to predict future state data are described herein including at least with respect to FIGS. 1B-1C and act 404 of process 400 shown in FIG. 4.

In some embodiments, the configured forecasting engine 114 is used to process at least some of the state data 111 to predict the future state data 115. For example, this may involve processing at least some of the state data 111 using at least one forecasting model that was selected and trained using the configuring module 113.

In some embodiments, the future state data 115 is indicative of the future input(s) 102 and/or output(s) 104 of system(s) 110. For example, the future state data 115 may include a prediction of future value(s) for one or more of the input(s) 102. A future value for a particular input may represent the predicted value of that particular input at some future time point. For example, if temperature is an input of system(s) 110, then the future state data 115 may include an indication of a predicted value of the temperature at a future time point or multiple predicted values of the temperature at multiple future time points (e.g., a predicted time series). The future time point(s) may be any time point(s) following the period of time for which state data 111 was obtained, as aspects of the technology described herein are not limited in this respect. For example, the future time point(s) may represent time points occurring minutes, hours, days, and/or weeks following the period of time for which state data 111 was obtained.

Additionally or alternatively, the future state data 115 may include a prediction of future value(s) for one or more of the output(s) 104. A future value for a particular output may represent the predicted value of that particular output at some future time point. For example, if freshwater is an output of a desalination system, then the future state data 115 may include an indication of a predicted value of the volume of freshwater output by system(s) 110 at a future time point or multiple predicted values of the volume of freshwater at multiple future time points (e.g., a predicted time series). The future time point(s) may be any time point(s) following the period of time for which state data 111 was obtained, as aspects of the technology described herein are not limited in this respect. For example, the future time point(s) may represent time points occurring minutes, hours, days, and/or weeks following the period of time for which state data 111 was obtained.

As shown in FIG. 1A, the future state data 115 may be used to predict future waste 117 at act 116. In some embodiments, the predicting the future waste 117 includes using the future state data 115 to compute one or more waste metrics for one or more future time points (e.g., the future time point(s) for which the future state data 115 was obtained). Examples of waste metrics are described with respect to waste 106. In some embodiments, the waste metrics are components of a waste vector. The future waste 117 may be predicted from the future state data 115 using the techniques described herein including at least in the section entitled “Example Waste Prediction Techniques.” However, it should be appreciated that any other suitable techniques for predicting future waste 117 using future state data 115 can be used to predict the future waste 117, as aspects of the technology described herein are not limited in this respect.

In some embodiments, target waste 118 is specified for the system(s) 110. In some embodiments, the target waste 118 comprises one or more target waste metrics for the system(s) 110. For example, the target waste metric(s) may be components of a target waste vector. In some embodiments, the target waste 118 is a science-based target (e.g., from the Science Based Target Initiative (SBTi)). The target waste 118 may be obtained from one or more user(s) (e.g., by the user(s) specifying the target waste 118 and/or otherwise providing target waste 118 as input to computing device(s)) and/or determined using any other suitable techniques, as aspects of the technology described herein are not limited in this respect.

In some embodiments, at act 119, technique 100 includes determining at least one degree of variance between the future waste 117 and the target waste 118 specified for the system(s) 110. In some embodiments, when the future waste 117 and target waste 118 are each represented as a respective vector (e.g., vectors of waste metrics), then determining the at least one degree of variance between the future waste 117 and target waste 118 may involve determining the Manhattan (L1) distance, the Euclidean (L2) distance, the L1-norm, the L2-norm, and/or any other measure of variance (or similarity) between the two vectors, as aspects of the technology described herein are not limited in this respect. In some embodiments, individual waste metrics predicted as future waste 117 may directly be compared to the corresponding waste metrics indicated as target waste 118. For example, this may include determining a difference between a future waste metric and a corresponding target waste metric.

In some embodiments, determining the at least one degree of variance includes determining at least one degree of variance for system(s) 110 as a whole based on the future waste predicted for the system(s) 110 as a whole and the target waste indicated for the system(s) 110 as a whole. Additionally or alternatively, determining the at least one degree of variance may include determining at least one degree of variance for each of one or more individual components of system(s) 110 and/or each of one or more individual system(s) of system(s) 110. For example, the at least one degree of variance may indicate a degree of variance between future waste predicted for a particular component or system and the target waste indicated for the particular component or system.

In some embodiments, act 119 optionally includes determining confidence(s) in the determined degree(s) of variance. In some embodiments, determining a confidence in a degree of variance includes comparing the determined degree of variance to historical variance data. This may include comparing the degree of variance to a distribution of historical variances determined for the system(s) 110 (or system(s) or component(s) thereof). For example, in some embodiments, determining the confidence in a degree of variance includes determining a value indicative of the position of the degree of variance relative to the distribution of historical variances. This may include, for example, determining a z-score, percentile, or any other value indicative of the position of a degree of variance relative to the distribution of historical variances, as aspects of the technology described herein are not limited in this respect.

At act 125, illustrative technique 100 includes generating an output indicating the at least one degree of variance and (optionally) the confidence therein. In some embodiments, generating the output includes generating text and/or one or more graphics indicating the at least one degree of variance and (optionally) the confidence. For example, the output may categorize the at least one degree of variance and/or confidence according to its value (e.g., high, medium, low, etc.). The output may include any suitable graphics and/or text arranged in any suitable arrangement, as aspects of the technology described herein are not limited in this respect. The output may be generated in the form of a report, a graphical user interface, or any other suitable format, as aspects of the technology described herein are not limited in this respect.

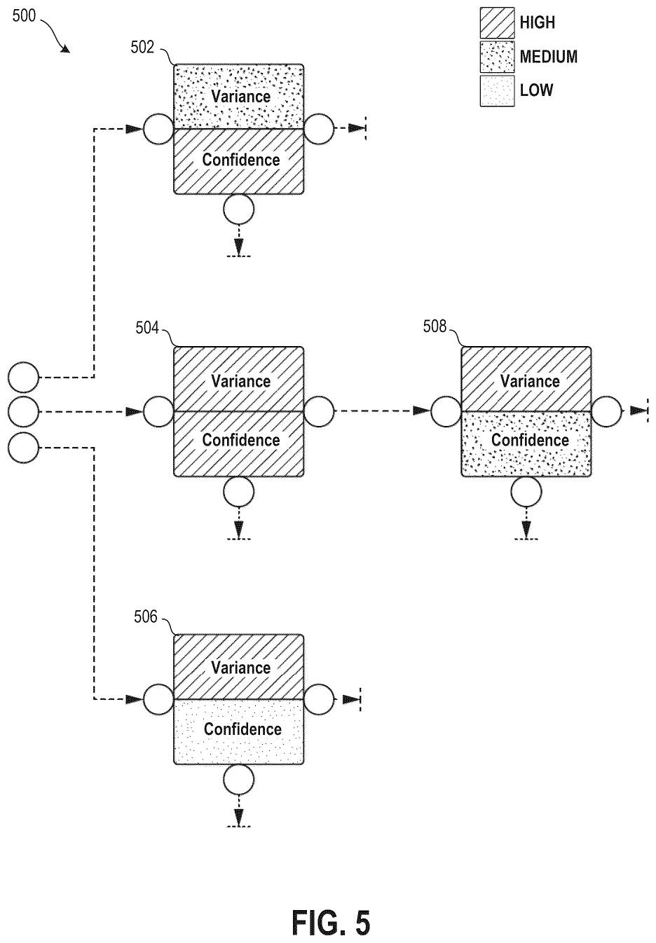

FIG. 5 shows an example 500 of graphics that may convey the at least one degree of variance and confidence therein. As shown in FIG. 5, the graphics display four components (components 502, 504, 506, and 508) of a system. For each component, the graphics indicate a degree of variance between future and target waste for the particular component, and a degree of confidence therein. For example, different patterns and/or colors may be used to indicate whether the degree of variance and/or confidence is high, medium, or low.

Referring again to FIG. 1A, in some embodiments, illustrative technique 100 includes determining whether to update one or more values of the input(s) 102. In some embodiments, this includes (i) determining whether the system(s) include one or more anomalies and (ii) determining to update one or more input value(s) after one or more anomalies are identified for the system(s). For example, identifying one or more anomalies for the system may be based on the determined degree(s) of variance and (optionally) the confidence(s) therein. For example, when a degree of variance and (optionally) the confidence therein satisfies one or more criteria, then illustrative technique 100 may include determining that there is an anomaly present in the system, and thus determining that input value(s) should be updated. The one or more criteria may include one or more threshold values. For example, determining whether the degree of variance satisfies the one or more criteria may include determining whether the degree of variance is greater than (or less than) or equal to a respect threshold value. Determining whether the confidence in the degree of variance satisfies the one or more criteria may include determining whether the confidence is greater than (or less than) or equal to a respective threshold value.

In some embodiments, the decision about whether to update the input values is made by one or more user(s). For example, the user(s) may use the output generated at act 125 to make the decision. For example, where the output indicates that there is a high degree of variance between future waste and target waste for a particular component of the system, and that there is a high confidence in that degree of variance, then the user may decide to adjust one or more values of the inputs to that component. By contrast, if the degree of variance is low and/or the confidence in the degree of variance is low, then the user may decide to not adjust the values of the inputs. Additionally or alternatively, the decision about whether to update the input values may be made using one or more computing device(s) (e.g., computing device(s) 305 shown in FIG. 3).

If, at act 120, it is determined that the input value(s) should not be updated, then one or more preceding act(s) of illustrative technique 100 may be repeated. For example, additional state data 111 (e.g., more recently obtained state data) may be used by the previously-configured forecasting engine 114 to predict updated future state data 115 for system(s) 110. The updated future state data 115 may be use, at act 116, to predict updated future waste 117, which may then be used, at act 119, to predict updated degree(s) of variance and (optionally) confidence(s) therein.

If, at act 120, it is determined that the input value(s) should be updated, then illustrative technique 100 proceeds to act 121. Act 121 involves determining whether to identify one or more outliers of the system(s) 110. An outlier may be a component, a group of components, a system, or group of systems associated with causing variance in the future waste relative to the target waste. In some embodiments, identifying outlier(s) helps to identify the particular component(s) and/or system(s) (e.g., the outlier(s)) for which the input values should be updated to change the future waste and/or output(s) of the system(s) 110. Thus, the decision at act 120 may depend on the complexity of the system(s) 110. For example, if the system(s) 110 include a single component, then there may be no reason to narrow down the input(s) 102. However, if the system(s) include more than one component, more than a threshold number of components, or more than a threshold number of systems, then it may be determined, at act 120, to proceed with identifying outlier(s).

If, at act 121, it is determined the one or more outliers should be identified, then illustrative technique 100 proceeds to act 122, at which the outlier(s) are identified. In some embodiments, the outlier(s) are identified based on (i) the state data 111 for individual system(s) and/or component(s), (ii) past state data obtained for the system(s) and/or component(s), and/or how the system(s) and/or component(s) are connected to one another. Example techniques for identifying outliers are described herein including at least in the section entitled “Example Outlier Identification Techniques.”

In some embodiments, act 123 includes determining updated values for input(s) to one or more components or systems of system(s) 110 (e.g., the outlier(s) identified at act 122). For example, in the context of a water desalination system, determining updated values of one or more inputs may include determining an updated flow rate of saltwater intake, updated amounts and/or types of chemicals added to the water, and/or updated desalination system temperatures, among others. In some embodiments, determining the updated input value(s) includes optimizing (e.g., maximizing or minimizing) an objective function that describes the relationship between the input(s) 102, output(s) 104, and/or waste 106 of system(s) 110. Example techniques for determining updated input value(s) are described herein including at least in the section entitled “Example System Optimization Techniques.”

At act 126, illustrative technique 100 include applying the updated input value(s) to the input(s) 102 of system(s) 110. In some embodiments, the input values are updated by one or more user(s) of the system(s) 110. Additionally or alternatively, input value(s) may be updated automatically (e.g., using system(s) automation module 385 shown in FIG. 3).

After the updated input value(s) are applied to system(s) 110, one or more acts of illustrative technique 100 may be repeated for additional state data obtained from system(s) 110.

FIG. 1B is a diagram depicting an illustrative technique 140 for using the configuring module 113 to configure forecasting engine 114 to predict future state data 115, given state data 111 and (optionally) training data 112 as input.

As shown in FIG. 1B, act 152 of technique 140 includes determining whether the system(s) 110 include a single system (e.g., system 210 shown in FIG. 2A) or multiple systems (e.g., collection of systems 260 shown in FIG. 2B). In some embodiments, the determination is based on data about the system(s) 110. For example, data about the system(s) may provide an indication as to the number of systems included in system(s) 110. The data about the system(s) 110 may be obtained from one or more users, one or more data store(s), and/or from any other suitable data source, as aspects of the technology described herein are not limited in this respect.

If system(s) 110 include multiple systems, then illustrative technique 140 proceeds to act 170. At act 170, state data 111 is processed using dynamic mode decomposition (DMD) to predict the future state data 115. Example techniques for processing state data using DMD are described herein including at least in the section entitled “Example Forecasting Models.”

If system(s) 110 includes a single system, then illustrative technique proceeds to act 154. At act 154, training data 112 is obtained.

At act 156, illustrative technique 140 includes determining whether multivariate or univariate forecasting (or both) should be used to predict the future state data 115. For example, multivariate forecasting may be used to predict future state data for one subset of input(s) and/or output(s), while univariate forecasting may be used to predict future state data for different subset of input(s) and/or output(s). In some embodiments, training data 112 is used to determine whether to use multivariate or univariate forecasting. For example, the training data 112 may be analyzed to identify relationships (e.g., correlations, interdependencies, etc.) between different inputs and/or outputs. Relationships between inputs and/or outputs may indicate that changes in a particular input could directly impact one or more other inputs or outputs. Thus, act 156 may include determining to use multivariate forecasting to predict future state data for input(s) and/or output(s) that are related in some way and to use univariate forecasting to predict future state data for input(s) and/or output(s) that are independent (e.g., changes in one input or output does not impact any other input or output).

If univariate forecasting is selected for at least one input or output at act 156, then illustrative technique 140 proceeds to act 158. At act 158, one or more characteristics of the training data 112 are identified. In some embodiments, identifying the one or more characteristics includes determining whether the time series in the training data have random noise. This may include, in some embodiments, quantifying an amount or degree of random noise in the time series and determining whether the amount or degree of random noise is greater than or equal to a respective threshold. If the amount or degree of random noise is greater than or equal to the threshold, then the training data may be characterized has having random noise. Additionally or alternatively, identifying the one or more characteristics may include determining whether time series in the training data are short or otherwise include less than a threshold number of data points. Short time series may be characterized as vulnerable to overfitting or unforecastable.

At act 160, at least one univariate forecasting model is selected using the characteristic(s) identified at act 158. In some embodiments, the at least one univariate forecasting model is selected from among a vector autoregressive (VAR) model, a recurrent neural network (RNN), and an autoregressive moving average model (ARMA). For example, the RNN may be a long short-term memory (LSTM) RNN. The ARMA model may be an autoregressive integrated moving average (ARIMA) model. In some embodiments, the VAR model, RNN, or ARMA model are selected when time series in the training data are characterized as having random noise. In some embodiments, the VAR or ARMA model are selected when time series in the training data are characterized as being vulnerable to overfitting or unforecastable.

In some embodiments, configuring module 113 is further configured to train the univariate forecasting model selected at act 160. For example, the configuring module 113 may train the selected univariate forecasting model using training techniques known in the art using the training data 112.

At act 162, at least some of the state data 111 is processed using the selected and trained univariate forecasting model(s) to predict at least some of the future state data 115. For example, the state data for the particular input(s) and/or output(s) for which the univariate forecasting model(s) were selected may be processed to predict the future state data for those particular input(s) and/or output(s).

If multivariate forecasting is selected for at least one input or output at act 164, then illustrative technique 140 proceeds to act 164. At act 164, the training data 112 (e.g., the time series included in the training data 112) is processed using temporal clustering to identify one or more characteristics of the training data. In some embodiments, the temporal clustering technique is selected from among Euclidean distance temporal clustering, shape-based temporal clustering, dynamic time warping, or any other suitable temporal clustering technique that can be used to cluster time series, as aspects of the technology described herein are not limited in this respect. Example temporal clustering techniques are described herein including at least in the section entitled “Example Temporal Clustering Techniques.”

In some embodiments, after the temporal clustering techniques are used to cluster time series in the training data into a plurality of clusters, one or more characteristics are identified for time series in the clusters. For example, this may include determining a degree of correlation between time series in a particular cluster, whether a non-linear relationship exists among time series in a particular cluster, amount(s) of data in the time series in a particular cluster, and/or an amount or degree of noise in the time series in a particular cluster.

At act 166, at least one multivariate forecasting model is selected using the one or more characteristics identified at act 164. For example, the at least one multivariate forecasting model may be selected from among a vector autoregressive (VAR) model, a recurrent neural network (RNN) model, decision tree model, and an autoregressive moving average (ARMA) model. For example, the RNN may be a long short-term memory (LSTM) RNN. The decision tree model may be a gradient-boosted (e.g., XGBoost) decision tree model. The ARMA model may be an autoregressive integrated moving average (ARIMA) model. In some embodiments, the VAR model or RNN may be selected for forecasting particular input(s) or output(s) when there are linear interdependencies between the time series in the training data corresponding to those input(s) or output(s). In some embodiments, the RNN or decision tree model may be selected for forecasting particular input(s) or output(s) when there are complex and non-linear dependencies between time series in the training data corresponding to those input(s) or output(s). In some embodiments, the RNN or decision tree model may be selected for forecasting particular input(s) or output(s) when there are non-linear relationships between the time series in the training data corresponding to those input(s) or output(s). In some embodiments, the VAR or ARMA model may be selected for forecasting particular input(s) or output(s) when the time series in the training data corresponding to those particular input(s) or output(s) are short, where overfitting is a concern, and/or where the time series are unforecastable. In some embodiments, the VAR or ARMA model may be selected for forecasting particular input(s) or output(s) when the time series in the training data corresponding to those particular input(s) or output(s) have an amount or degree of noise that is greater than or equal to a threshold.

In some embodiments, configuring module 113 is further configured to train the multivariate forecasting model selected at act 166. For example, the configuring module 113 may train the selected multivariate forecasting model using training techniques known in the art using the training data 112.

At act 168, at least some of the state data 111 is processed using the selected and trained univariate forecasting model(s) to predict at least some of the future state data 115. For example, the state data for the particular input(s) and/or output(s) for which the multivariate forecasting model(s) were selected may be processed to predict the future state data for those particular input(s) and/or output(s).

FIG. 1C is a diagram depicting an illustrative technique 180 for using the configuring module 113 to select and train a multivariate forecasting model to predict future state data 115. At act 174, temporal feature aggregation of time series included in training data 112 is performed. In some embodiments, performing temporal feature aggregation involves extracting features from the time series such as, for example, statistical measures (e.g., mean and variance), trend information, domain-specific features, or any other relevant features, as aspects of the technology described herein are not limiting in this respect. In some embodiments, features extracted from different time series are normalized to ensure comparability between different time series.

At act 176, a temporal clustering technique is selected from among Euclidean distance temporal clustering, shape-based temporal clustering, dynamic time warping, or any other suitable temporal clustering technique that can be used to cluster time series, as aspects of the technology described herein are not limited in this respect. In some embodiments, the temporal clustering technique is selected based on feature(s) of the time series extracted at act 174. For example, Euclidean distance temporal clustering may be selected when the time series have consistent time intervals between measurements and/or when the variations in the amplitude are more important than the variations in the shape of the series. Shape-based temporal clustering may be selected when the overall shape of the time series is more relevant than the specific values at each point. Dynamic time warping may be selected when the time series have different lengths or exhibit non-linear time distortions. Example temporal clustering techniques are described herein including at least in the section entitled “Example Temporal Clustering Techniques.”

At act 178, the time series are clustered using the temporal clustering technique selected at act 176 to obtain a plurality of clusters.

At act 182, one or more characteristics of the time series in each cluster are determined. For example, this may include determining a degree of correlation between time series in a particular cluster, whether a non-linear relationship exists among time series in a particular cluster, amount(s) of data in the time series in a particular cluster, and/or an amount or degree of noise in the time series in a particular cluster.

At act 166, at least one multivariate forecasting model is selected using the determined characteristic(s). Act 166 is described with respect to FIG. 1B.

At act 184, the time series are split into training, testing, and validation sets. At act 186, the at least one multivariate forecasting model is trained, tested, and validated using the training, testing, and validation sets, respectively.

At act 188, if the at least one multivariate forecasting model includes only one multivariate forecasting model for a particular input and/or output of system(s) 110, then illustrative technique proceeds to act 168, which is described with respect to FIG. 1B.

Else, if the at least one forecasting model includes multiple forecasting models for a particular input and/or output of system(s) 110, technique 180 proceeds to act 190. At act 190, the trained multivariate forecasting models are ensembled. In some embodiments, ensembling the trained multivariate forecasting models involves combining the predictions of the individual models to obtain a prediction. For example, combining the predictions of the individual models may involve determining a (weighted) average of the predictions output by the individual models.

FIG. 3 is a block diagram of an example system 300 for managing waste associated with one or more systems, according to some embodiments of the technology described herein.

System 300 includes one or multiple computing device(s) 305. In some embodiments, when the computing device(s) 305 includes multiple computing devices, each of the computing devices may be used to perform the same process or processes. In some embodiments, when the computing device(s) 305 includes multiple computing devices, the computing devices are used to perform different processes and/or different acts of a process.

In some embodiments, when computing device(s) 305 includes multiple computing devices, the multiple computing devices may be configured to communicate via at least one communication network such as the Internet or any other suitable communication network(s), as aspects of the technology described herein are not limited in this respect. For example, the multiple computing devices may be part of a cloud computing environment. The cloud computing environment may be a public cloud computing environment, a private computing environment or a hybrid computing environment operating using a combination of publicly accessible and private infrastructure.

The computing device(s) 305 may be operated by one or more user(s) 340. In some embodiments, the user(s) 340 provide, as input to the computing device(s) 305, a specification of one or more inputs and/or outputs of system(s) 310. Additionally or alternatively, user(s) 340 may provide input specifying processing or other methods to be performed on state data (e.g., time series) obtained for the system(s) 310. User(s) 340 may provide input by uploading one or more files and/or interacting with a user interface of the computing device 305.

In some embodiments, the computing device(s) 305 are configured to have software 350 execute thereon to perform various functions in connection with managing waste associated with a system. In some embodiments, software 350 includes a plurality of modules. A module may include processor-executable instructions that, when executed by at least one computer hardware processor, cause the at least one computer hardware processor to perform function(s) of the module. Such modules are sometimes referred to herein as “software modules,” each of which includes processor-executable instructions configured to perform one or more acts of one or more processes, such as process 400 shown in FIG. 4.

In some embodiments, the configuring module 355 obtains data about system(s) 310 and/or training data from system(s) 310, system(s) data store 320, and/or user(s) 340. Additionally or alternatively, the configuring module 355 may obtain training data from system(s) 310, system(s) data store 320, and/or user(s) 340. For example, the training data may include training data 112 shown in FIGS. 1A-1C.

In some embodiments, the configuring module 355 configures a forecasting engine to predict future state data for the system(s) 310. For example, the configuring module 355 may be configuring module 113, shown in FIGS. 1A-1B.

In some embodiments, as part of configuring the forecasting engine, the configuring module 355 may select at least one forecasting model from among dynamic mode decomposition, a univariate forecasting model, and a multivariate forecasting model. The selection may be based on (i) a number of the system(s) 310, and/or (ii) characteristic(s) of state data (e.g., training data) obtained for the system(s) 310. To this end, in some embodiments, the configuring module 355 is configured to use the number of systems to select from between (i) dynamic mode decomposition and (ii) a univariate or multivariate forecasting model. If the univariate or multivariate forecasting model is selected, then the configuring module 355 may further be configured to analyze training data to identify the one or more characteristic(s) of the state data. For example, the configuring module 355 may be configured to perform temporal feature aggregation and/or temporal clustering of time series, and identify characteristics of time series based on results of performing temporal feature aggregation and/or clustering. Example techniques for configuring a forecasting engine to predict future state data are described herein including at least with respect to FIGS. 1A-1C and act 404 of process 400 shown in FIG. 4.

The configuring module 355 may additionally or alternatively be configured to train selected forecasting model(s). For example, the configuring module 355 may obtain training, validation, and/or test data (e.g., from system(s) 310, system(s) data store 320, and/or user(s) 340). The training, validation, and/or test data may include state data for system(s) 310 (e.g., historical state data). For example, the historical state data may include time series for one or more inputs and/or time series for one or more outputs of the system(s) 310. The configuring module 355 may be configured to use the obtained training, validation, and/or test data to train, validate, and/or test the selected forecasting model(s) to predict future state data for the system(s) 310. In some embodiments, the configuring module 355 may provide the trained forecasting model(s) to the forecasting module 360 and/or trained model data store 330. For example, the configuring module 355 may provide the values of parameters of the trained forecasting model(s) to the forecasting module 360 and/or to the trained model data store 330 for storage thereon.

In some embodiments, the forecasting module 360 obtains at least one trained forecasting model from the configuring module 355, trained model data store 330, and/or user(s) 340. Additionally or alternatively, the forecasting module 360 may obtain state data from system(s) 310, system(s) data store 320, and/or user(s) 340. For example, the state data may include state data 111 shown in FIGS. 1A-1C.

In some embodiments, the forecasting module 360 is configured to process state data obtained for system(s) 310 to predict future state data for the system(s) 310. For example, the forecasting module 360 may be forecasting engine 114 shown in FIGS. 1A-1B. In some embodiments, the forecasting module 360 may process the state data using DMD, one or more trained univariate forecasting model, and/or one or more trained multivariate forecasting models. The forecasting module 360 may, additionally or alternatively, ensemble the trained univariate or multivariate forecasting models to combine the predictions of individual models. Example techniques for predicting future state data are described herein including at least with respect to FIG. 1A and act 408 of process 400 shown in FIG. 4. In some embodiments, the forecasting module 360 is configured to provide the predicted future state data to future waste prediction module 365, system(s) data store 320, input optimization module 380, and/or report generation module 390.

In some embodiments, the future waste prediction module 365 is configured to use the future state data predicted for the system(s) 310 to predict future waste (e.g., future waste 117 shown in FIG. 1A) for the system(s) 310. For example, the future waste may be predicted by solving one or more objective functions using the predicted future state data. Example techniques for predicting future waste are described herein including at least with respect to FIG. 1A, act 410 of process 400 shown in FIG. 4, and in the section entitled “Example Waste Prediction Techniques.” In some embodiments, the future waste prediction module 365 is configured to provide data indicative of the future waste to variance determination module 370, system(s) data store 320, outlier identification module 375, input optimization module 380, and/or report generation module 390.

In some embodiments, the variance determination module 370 is configured to obtain data indicative of the future waste predicted for the system(s) 310 from future waste prediction module 365, system(s) data store 320, and/or user(s) 340. In some embodiments, the variance determination module 370 is configured to obtain data indicative of target waste (e.g., target waste 118 shown in FIG. 1A) for the system(s) 310 from system(s) data store 320 and/or user(s) 340.

In some embodiments, the variance determination module 370 is configured to determine at least one degree of variance between the predicted future waste and the target waste indicated for system(s) 310. For example, the variance determination module 370 may determine a single degree of variance between future waste predicted for at least a portion of the system(s) 310 and a target waste indicated for the portion. Alternatively, the variance determination module 370 may determine multiple degrees of variance between future waste predicted for multiple portions (e.g., multiple components, multiple systems, etc.) and the target waste indicated for those portions of the system. In some embodiments, the variance determination module 370 is further configured to determine value(s) indicative of confidence associated with the determined degree(s) of variance. In some embodiments, the variance(s) and (optionally) associated confidence(s) are provided to system data store(s) 320, outlier identification module 375, and/or input optimization module 380. Example techniques for determining a degree of variance and a confidence therein are described herein including at least with respect to FIG. 1A and act 412 of process 400 shown in FIG. 4.

In some embodiments, the variance determination module 370 is further configured to determine whether the system(s) 310 include one or more anomalies. For example, the variance determination module 370 may be configured to compare the determined degree(s) of variance and (optionally) an associated value(s) indicative of confidence to respective thresholds. If the degree(s) of variance are greater than or equal to the respective threshold and (optionally) if the associated value(s) indicative of confidence is greater than or equal to the respective threshold), then the variance determination module 370 may determine that the system(s) 310 include one or more anomalies. This may indicate that one or more inputs to the system(s) 310 should be updated. For example, anomalies identified by the variance determination module 370 may be provided to input optimization module 380 such that module 380 can be used to determined updated input(s) for system(s) 310.

In some embodiments, the outlier identification module 375 is configured to obtain data about the system(s) 310 from system(s) 310, system(s) data store 320, and/or user(s) 340. For example, the data about the system(s) 310 may indicate the number of systems, the components of each system, the connections between different components and/or systems, and/or the inputs and outputs of each component or system. In some embodiments, the outlier identification module 375 is configured to obtain data indicative of the future waste predicted for the system(s) 310 from future waste prediction module 365, system(s) data store 320, and/or user(s) 340.

In some embodiments, if system(s) 310 include more than one component or system, then outlier identification module 375 may be configured to identify particular component(s), system(s), and/or clusters of components or systems within system(s) 310. As described herein, identifying outliers may help to pinpoint the portion(s) of system(s) 310 that result in more waste compared to other portion(s) of the system(s) 310. In some embodiments, the outlier identification module 375 is configured to identify the outlier(s) by representing system(s) 310 as a graph comprising nodes and edges. For example, the nodes may represent individual components or systems, while the edges represent connections between the nodes. In some embodiments, the outlier identification module 375 is further configured to identify outlier node(s) or clusters of nodes. The outlier node(s) and/or cluster(s) may be provided to the input optimization module 380 such that module 380 may identify updated input(s) for the components and/or systems corresponding to the identified outliers. Example techniques for identifying outlier(s) are described herein including at least with respect to FIG. 1A and in the section entitled “Example Outlier Identification Techniques.”

In some embodiments, the input optimization module 380 is configured to obtain state data and/or future state data from system(s) 310, system(s) data store 320, forecasting module 360, and/or user(s) 340. In some embodiments, the input optimization module 380 is configured to obtain value(s) indicative of future waste from future waste prediction module 365, system(s) data store 320, and/or user(s) 340. In some embodiments, the input optimization module 380 is configured to obtain at least one degree of variance and (optionally) the confidence therein from variance determination module 370, system(s) data store 320, and/or user(s) 340. In some embodiments, the input optimization module 380 is configured to obtain an indication of one or more outliers from outlier identification module 375, system(s) data store 320, and/or user(s) 340.

In some embodiments, the input optimization module 380 is configured to determine updated value(s) for one or more inputs to system(s) 310. For example, as described herein, the input optimization module 380 may be configured to determine the updated value(s) by optimizing (e.g., maximizing or minimizing) one or more objective functions representing waste output by the system(s) 310. In some embodiments, the input optimization module 380 is configured to determine the updated input value(s) for only one or more portions (e.g., one or more components or one or more systems) of the system(s) 310. The one or more portions of the system(s) 310 may be determined based on the determined degree(s) of variance and (optionally) the confidence therein. Additionally or alternatively, the one or more portions of the system(s) 310 may be determined based on the outliers identified by outlier identification module 375. Example techniques for determining updated input values are described herein including at least with respect to FIG. 1A and in the section entitled “Example System Optimization Techniques.”

In some embodiments, the system(s) automation module 385 is configured to obtain updated input values from input optimization module 380, system(s) data store 320, and/or user(s) 340. In some embodiments, the system(s) automation module 385 is further configured to obtain an indication of the component(s) and/or system(s) for which the input values are to be updated. For example, the system(s) automation module 385 may be configured to obtain the indication of the component(s) and/or system(s) from the input optimization module 380, system(s) data store 320, and/or user(s) 340.

In some embodiments, the system(s) automation module 385 is configured to cause the updated input value(s) to be applied to system(s) 310. For example, the system(s) automation module 385 may be configured to transmit instructions to device(s) and/or machinery used to apply the input(s) to the system(s). The instructions may cause the device(s) and/or machinery to change the input(s) provided to system(s) 310. For example, when the system is a butter churning system, system(s) automation module 385 may be configured to transmit instructions to a churn configured to cause the churn to update a churn speed and/or a churn time. Example techniques for applying updated inputs to system(s) and applications thereof are described herein including at least with respect to FIG. 1A and in the section entitled “Examples.”

In some embodiments, the report generation module 390 is configured to obtain data from one or more of the software modules, system(s) data store 320, and/or user(s) 340. The report generation module 390 may be configured to use the obtained data to generate one or more reports. For example, the report generation module 390 may be configured to generate a report that indicates variance(s) and (optionally) confidence(s) determined by variance determination module 370. FIG. 5 shows an example of such a report. Additionally or alternatively, the report may indicate state data, future state data, and/or future waste for the system(s) 310. Additionally or alternatively, the report may indicate one or more updated input values, such as those that may be determined by input optimization module 380. It should be appreciated that the report generation module 390 may be configured to generate a report indicating any other suitable information associated with system 300, in any suitable format, as aspects of the technology described herein are not limited in this respect.

In some embodiments, the report generation module 390 is configured to generate a report that includes a recommendation for performing one or more acts. The one or more acts may include act(s) to be performed by user(s) 340 and/or using one or more computing device(s) (e.g., computing device(s) 305) and/or automated system(s) (e.g., system(s)). For example, the report may include a recommendation for applying updated input value(s) to input(s) of system(s) 310.

As shown in FIG. 3, software 350 also includes a user interface module 395. User interface module 395 may be configured to generate a graphical user interface (GUI) through which user(s) 340 may provide input and/or view information generated by software 350 such as, for example, a report generated by report generation module 390. For example, in some embodiments, the user interface module 395 may be a webpage or web application accessed through an Internet browser. In some embodiments, the user interface module 395 may generate a GUI of an app executing on a user's mobile device. In some embodiments, the user interface module 395 may generate a number of selectable elements through which a user may interact. For example, the user interface module 395 may generate dropdown lists, checkboxes, text fields, or any other suitable element, as aspects of the technology described herein are not limited in this respect.

In some embodiments, the system(s) data store 320 stores information about system(s) 310, state data obtained from system(s) 310, the output of one or more of the software modules, or any other suitable information as aspects of the technology described herein are not limited in this respect. In some embodiments, the system(s) data store 320 includes any suitable type of data store (e.g., a flat file, a database system, a multi-file, etc.) and may store data in any suitable format, as aspects of the technology described herein are not limited in this respect. The system(s) data store 320 may be part of software 350 (not shown) or excluded from software 350, as shown in FIG. 3.

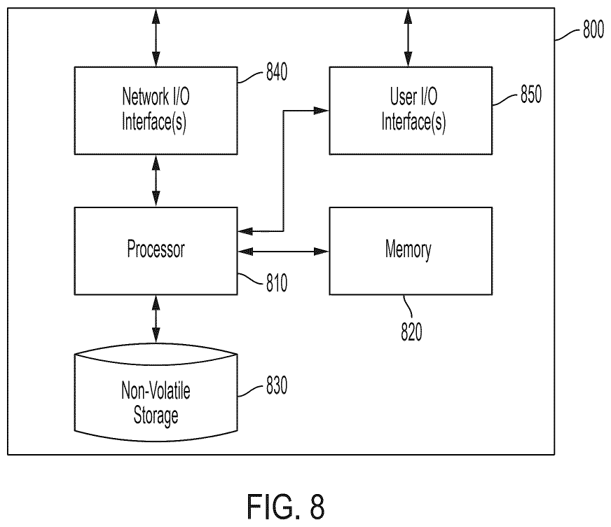

FIG. 4 is a flowchart of an illustrative process 400 for managing waste associated with one or more systems, according to some embodiments of the technology described herein. One or more of the acts of process 400 may be performed automatically by any suitable computing device(s). For example, act(s) may be performed by a laptop computer, a desktop computer, one or more servers, in a cloud computing environment, computing device(s) 305 described herein with respect to FIG. 3, computing system 800 described herein with respect to FIG. 8, and/or in any other suitable way, as aspects of the technology described herein are not limited in this respect.

At act 402, state data (e.g., state data 111 shown in FIGS. 1A-1C) is obtained for one or more systems (e.g., system(s) 110 shown in FIGS. 1A-1B). In some embodiments, the state data indicates (i) a first set of time series for one or more inputs (e.g., input(s) 102 shown in FIGS. 1A-1B), and/or (ii) a second set of time series for one or more outputs (e.g., output(s) 104 shown in FIGS. 1A-1B). Example techniques for obtaining state data for one or more systems are described herein including at least with respect to FIG. 1A.

At act 404, a forecasting engine (e.g., forecasting engine 114 shown in FIGS. 1A-1B) is configured to predict future state data (e.g., future state data 115 shown in FIGS. 1A-1C) for the one or more systems. In some embodiments, configuring the forecasting engine includes, at act 406, selecting at least one forecasting model based on (i) a number of the one or more systems, and/or (ii) one or more characteristics of the state data. Example techniques for configuring a forecasting engine are described herein including at least with respect to FIGS. 1A-1C. Example forecasting models are described herein including at least with respect to FIGS. 1A-1C and in the section entitled “Example Forecasting Models.”

At act 406, the state data is processed using the configured forecasting engine to predict future state data (e.g., future state data 115 shown in FIGS. 1A-1C) for the one or more systems. In some embodiments, the future state data indicates: (i) one or more predicted input values for the one or more inputs, and/or (ii) one or more predicted output values for the one or more outputs. Example techniques for processing state data using a configured forecasting engine are described herein including at least with respect to FIG. 1A.

At act 410, one or more values indicative of future waste (e.g., future waste 117 shown in FIG. 1A) associated with the one or more systems are predicted using at least some (e.g., all) of the future state data predicted at act 408. Example techniques for predicting future waste are described herein including at least with respect to act 116 shown in FIG. 1A and in the section entitled “Example Waste Prediction Techniques.”

Act 412 includes determining (i) at least one degree of variance between the one or more values indicative of the future waste and one or more values indicative of a target waste (e.g., target waste 118 shown in FIG. 1A) specified for the one or more systems and (ii) a respective confidence associated with the at least one degree of variance. For example, the one or more values indicative of future waste may include (i) one or more values indicative of future waste for a particular component of the one or more systems, and/or (ii) one or more values indicative of future waste for a particular system of the one or more systems. As described herein with respect to FIG. 1A, the one or more values indicative of future waste and/or target waste may include one or more waste metrics for a respective one or more types of waste. The one or more values indicative of future waste may be components of a future waste vector, and/or the one or more values indicative of the target waste may be components of a target waste vector. Example techniques for determining at least one degree of variance between the future and target waste and a confidence therein are described herein including at least with respect to act 119 shown in FIG. 1A.

At act 414, a report indicating the at least one degree of variance and (optionally) the confidence therein is output. For example, the report may include text and/or one or more graphics indicating the at least one degree of variance and (optionally) the confidence therein. The graphics and/or text may be arranged in any suitable arrangement and any suitable format, as aspects of the technology described herein are not limited in this respect. Example techniques for generating a report are described herein including at least with respect to act 125 shown in FIG. 1A. Examples of graphics that may be included in a report are shown in FIG. 5.

### Example Temporal Clustering Techniques

As described herein, including at least with respect to FIGS. 1A-1C and FIG. 4, some embodiments of the technology described herein relate to (i) selecting a temporal clustering technique, (ii) processing training data using the selected temporal clustering, and (iii) using the resulting clusters to select at least one multivariate forecasting model. Examples of temporal clustering techniques include Euclidean distance temporal clustering, shape-based temporal clustering, and dynamic time warping. The following sections describe example techniques for applying Euclidean distance temporal clustering, shape-based temporal clustering, and dynamic time warping to time series included in training data used for configuring a forecasting network.

### Euclidean Distance Temporal Clustering

The Euclidean distance method calculates the distance between two time series based on the Euclidean distance formula, shown in Equation 1. It measures the “as-the-crow-flies” distance between the two timeseries in a multi-dimensional space.

$$Euclidean = d ( {I}_{1} , {I}_{2} ) = {‖ {I}_{1} - {I}_{2} ‖}_{2} = \sqrt{{\sum }_{i = 1}^{t} {( {I}_{1 , i} - {I}_{2 , i} )}^{2}} \qquad ( Equation 1 )$$

where I₁ is a first time series and I₂ is a second time series in a set of vector I=I₁, I₂, I₃, . . . . Iₘ, where each vector can be of size t∈T where T is an integer indicating a number of historical records.

In some embodiments, performing the Euclidean distance temporal clustering involves: (i) preprocessing the time series data by normalizing the time series data; (ii) computing the Euclidian distance between each pair of input time series in the time series dataset; and (iii) applying a clustering algorithm to group the time series based on their Euclidian distance values. For example, the clustering algorithm may be the hierarchical density-based spatial clustering applications with noise (HDBSCAN) clustering algorithm.

Example Euclidean distance clustering techniques are also described by Berthold, M. and Höppner, F. (“On clustering time series using euclidean distance and pearson correlation.” arXiv preprint arXiv: 1601.02213 (2016).), which is incorporated by reference herein in its entirety.

### Shape-Based Temporal Clustering

Shape-based temporal clustering may be used to analyze and compare input time series based on their shape characteristics. In some embodiments, the shape-based temporal clustering involves extracting features that capture the overall shape or pattern of the time series, allowing for clustering and/or classification based on these shape features. This may involve, for example: (i) extracting statistical measures (e.g., mean, variance, skewness, kurtosis, etc.) from the time series, (ii) using Fourier transform to decompose input time series into its frequency components, (iii) decomposing the input time series into different scales using wavelet functions, and (iv) identifying sub-sequences within input time series that can differentiate between different classes by shapelet analysis. Shapelets may be subsequences of a time series that capture important characteristics or motifs within the data. Shapelets may be used for classification, clustering, and/or anomaly detection.

An example shape-based temporal clustering technique is described by Paparrizos, J. and Luis G. (“k-shape: Efficient and accurate clustering of time series.” Proceedings of the 2015 ACM SIGMOD international conference on management of data. 2015.), which is incorporated by reference herein in its entirety.

### Dynamic Time Warping

Dynamic Time Warping (DTW) finds an optimal alignment between the datapoints of two time series by warping the time axis. It allows for flexible matching by stretching or compressing the time axis to align corresponding points in the time series. The DTW algorithm works by constructing a distance matrix, where each cell represents the distance between two data points from the time series being compared. Starting from the top-left corner of the matrix, it finds the optimal path through the matrix by minimizing the accumulated distance. The optimal path represents the alignment that minimizes the total dissimilarity between the two timeseries.

The DTW algorithm is intended to align two vector sequences by turning the time axis repeatedly until the optimal match between the two sequences is found. This algorithm performs as a linear mapping of the axis to align the two signals. Suppose there are two vector sequences in t₁ and t₂ dimensional spaces, I₁=[I_{1,1}, I_{1,2}, . . . , I_{1,t}_{₁}] and I₂=[I_{2,1}, I_{2,2}, . . . , I_{2,t}_{₂}]. The two sequences are aligned on the sides of the box, with one above and the other on the left side. Both sequences start at the bottom left of the grid. In each cell, a measure of distance is placed, comparing the corresponding elements of two sequences. The distance between two points is calculated through Euclidean distance. The best match or alignment between these two sequences is the path through the grid, which minimizes the total distance between the two, which is called global distance. The entire distance (global distance) is calculated by finding and going through all possible routes through the grid, each calculating the overall distance. A new cell is calculated from the computation of previous computations using Equation 2.

$$DTW ( {I}_{1} , {I}_{2} ) = {min ( {\sum }_{( i , j ) ϵ π} {Dist ( {I}_{1 , i} , {I}_{2 , j} )}^{q} )}^{\frac{1}{q}} \qquad ( Equation 2 )$$

π is a set of sequences of sequences of indexed pairs of I₁ and I₂, which can be simplified as Equation 3:

$$DTW ( {I}_{1} , {I}_{2 , j} ) = \vert {I}_{1 , i} - {I}_{2 , j} \vert + min \{ D ( i - 1 , j - 1 ) , D ( i - 1 , j ) , D ( i , j - 1 ) \} \qquad ( Equation 3 )$$

For 1≤i≤t₁ and 1≤j≤t₂

Example DTW techniques are described by Cuturi, M. (“Fast global alignment kernels.” Proceedings of the 28th international conference on machine learning (ICML-11). 2011.), which is incorporated by reference in its entirety.

### Example Forecasting Models

As described herein, including at least with respect to FIGS. 1A-1C and FIG. 4, some embodiments of the technology described herein relate to selecting, training, and using at least one forecasting model to predict future state data for one or more systems. For example, the at least one forecasting model may include dynamic mode decomposition (DMD), a vector autoregressive (VAR) model, a recurrent neural network (RNN) model, decision tree model, and an autoregressive moving average (ARMA) model. For example, the RNN may be a long short-term memory (LSTM) RNN. The decision tree model may be a gradient-boosted (e.g., XGBoost) decision tree model. The ARMA model may be an autoregressive integrated moving average (ARIMA) model. The following sections describe examples of forecasting models.

### Dynamic Mode Decomposition

As described herein including at least with respect to FIG. 1B, some embodiments of the technology described herein relate to using dynamic mode decomposition (DMD) to predict future state data for system(s). For example, DMD may be used where the system(s) include multiple systems (e.g., collection of systems 260 shown in FIG. 2B). Example DMD techniques are described by Kutz, J. Nathan, et al. (Dynamic mode decomposition: data-driven modeling of complex systems. Society for Industrial and Applied Mathematics, 2016.), which is incorporated by reference herein in its entirety.

In some embodiments, DMD is used to predict X(t), which represents the value(s) of one or more input(s) and/or output(s) derived as a snapshot in time from 1 to T based on one or more sets of time series (e.g., state data).

An input vector matrix, I, can be expressed as an m*k*c-dimensional matrix with a shape of m×k, where k represents the number of system input(s) and/or output(s) observed in the state data, m represents the dimension of time series included in the state data, and c denotes the standardized inputs/outputs. An input vector, xₜ, of the input vector matrix I, represents a time series corresponding to a particular input or output of the systems, where xₜ∈R^{m}; t∈1, 2, 3 . . . T. If certain input(s) and/or output(s) are not applicable to a particular system, then their values can be set to zero.

This 2-dimensional matrix can be reshaped to single dimensional matrix with shape m=c*k. Hence this multi-dimensional matrix can be converted to matrix as X=[x₁ x₂ x_{T}]. Single Vector Decomposition is used to create a X′ matrix which represents as X′=[x₂ x₃ x_{T+1}], where xᵢ is column vector.

DMD seeks the leading spectral decomposition of best fit linear operator A that relates two snapshots matrix in time:

$${X}^{′} = AX \qquad ( Equation 4 )$$

Hence if x_{T} column vector is known, x_{T+1}=Ax_{T} can be approximated. Then following steps would be computed: (1) Compute the SVD of the matrix to obtain the left singular vectors, singular values, and right singular vectors, Y=UΣV^{T}. (2) Full Matrix A can be computed as A=X·X′.

However, since the most important eigen vectors are of interest, A may be recomputed by considering the first r eigen values by considering matrix A (r*r) matrix:

$${A}^{′} = {{X}^{′} ( U \sum {V}^{T} )}^{- 1} \qquad ( Equation 5 )$$

from which A′=U^{T}·A·U can be deduced, where it is projected back as reconstructed matrix:

$${A}^{′} = {{X}^{′} ( {V}^{T} )}^{- 1} {{X}^{′} ( \sum )}^{- 1} {U}^{- 1} \qquad ( Equation 6 )$$

$${A}^{′} = {{X}^{′} ( {V}^{- 1} )}^{- 1} {{y}^{′} ( \sum )}^{- 1} {u}^{- 1}$$

$${A}^{′} = {X}^{′} {V ( \sum )}^{- 1} {U}^{- 1}$$

The spectral decomposition of A′ is computed by leveraging Equation 7:

$${A}^{′} W = W \text{?} \qquad ( Equation 7 )$$

where [symbol] is the matrix containing eigen values of A′. The high-dimensional DMD is computed as:

$$∅ = {X}^{′} {V ( \sum )}^{- 1} W \qquad ( Equation 8 )$$

Then, x_{T+1} can be calculated using Equation 9:

$${x}_{T + 1} = ∅ \cdot {x}_{T} \qquad ( Equation 9 )$$

### Vector Autoregression (VAR)

In some embodiments, VAR is selected to process time series corresponding to input(s) and/or output(s) of one or more system(s) to obtain future state data (e.g., future values for the input(s) and/or output(s)) for the system(s).

The VAR model may be used to predict X(t), which represents the value(s) of one or more input(s) and/or output(s) at some future time, t. For example, X(t) may be predicted using Equation 10:

$$( Equation 10 )$$

$$\vec{X ( t )} = [ \begin{matrix}{x}_{1 , t} \\ {x}_{2 , t} \\ {x}_{k , t}\end{matrix} ] = [ \begin{matrix}{α}_{t , 1} \\ {α}_{t , 2} \\ {α}_{t , 3} \\ {α}_{t , n}\end{matrix} ] + ( [ [ \begin{matrix}{α}_{( 1 , 1 ) , 1} & … & {α}_{( 1 , k ) , 1} \\ ⋮ & ⋱ & ⋮ \\ {α}_{( k , 1 ) , 1} & … & {α}_{( k , k ) , 1}\end{matrix} ] ] \cdot [ \begin{matrix}{X}_{t - 1 , 1} \\ {X}_{t - 3 , 3} \\ {X}_{t - 3 , 3} \\ {X}_{t - k , n}\end{matrix} ] + [ \begin{matrix}{e}_{t , 1} \\ {e}_{t , 2} \\ {e}_{t , 3} \\ {e}_{t , k}\end{matrix} ]$$

VAR models can be estimated using various techniques such as, for example, ordinary least squares (OLS), maximum likelihood estimation (MLE), or Bayesian estimation. Example techniques for using VAR for multivariate time series are described by Zivot, E. and Wang, J. “Vector autoregressive models for multivariate time series.” Modeling financial time series with S-PLUS® (2006): 385-429.), which is incorporated by reference herein in its entirety.

### LSTM-Based RNN

In some embodiments, a neural network is used. The neural network may be a recurrent neural network (RNN). For example, the RNN may be a long short-term memory (LSTM) network such as a bidirectional LSTM network. LSTM networks are described by J. Schmidhuber and S. Hochreiter. (“Long short-term memory.” Neural Comput 9.8 (1997): 1735-1780), which is incorporated by reference herein in its entirety. The neural network may be trained using any suitable neural network optimization software. The optimization software may be configured to perform neural network training by gradient descent, stochastic gradient descent, or in any other suitable way. In some embodiments, the Adam optimizer is used. The Adam optimizer is described by Kingma, D. and Ba, J. ((2015) Adam: A Method for Stochastic Optimization. Proceedings of the 3rd International Conference on Learning Representations (ICLR 2015)), which is incorporated by reference herein in its entirety.

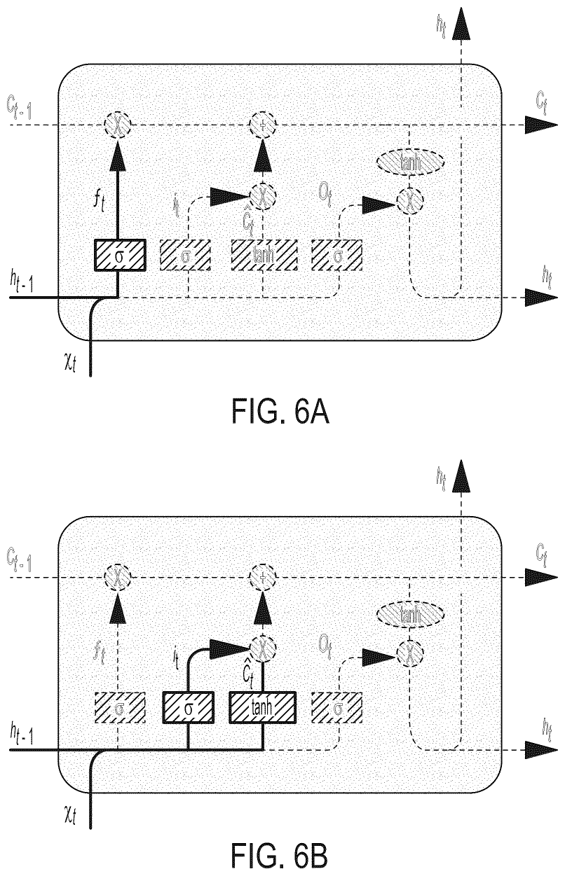

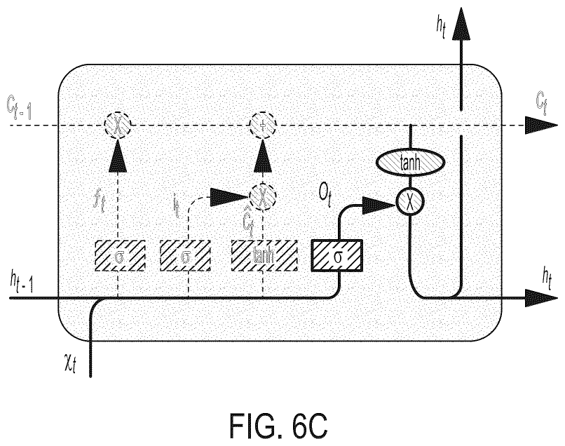

In an LSTM, the basic unit is called a “memory cell,” which maintains a cell state and has three main components. A cell has computing units, as shown in FIGS. 6A-6C. Each box represents LSTM cells which will take input/applied input/output from system denoted by x(t) and previous state of input hₜ₋₁ denotes the vector of values subjected to system. This leads to an activation function denoted by either passing through sigmoid function or tanh function presented in Equation 11:

$$σ * ( b + {( {W}_{I} )}^{T} \cdot [ {X}_{t} , {h}_{t - 1} ] ) or tanh * ( b + {( {W}_{I} )}^{T} \cdot [ {X}_{t} , {h}_{t - 1} ] ) \qquad ( Equation 11 )$$

where \vec{(W₁)}=[Wₓ, W_{y}]. Here σ is the sigmoid function, so the output is a vector where each element is between 0 and 1. This means that each σ⊗ layer acts as a multiplicative mask of the connecting vector.

FIG. 6A shows the forget gate. This gate determines which information from the previous cell state should be discarded. It takes the previous hidden state and current input as inputs, and outputs a forget vector that scales the previous cell state. The long-term state cₜ passes through the network interacting three times. The multiplication gate ⊗ “forgets” data from Cₜ₋₁ by making it with

$$σ * ( b + {( {W}_{x} )}^{T} \cdot {X}_{t} + {W}_{y}^{T} \cdot {h}_{t - 1} ) .$$

Here j denotes the variable in \vec{x}(t) and i represent the cell for which weights are used.

$$Result post Forget gate is = {c}_{t - 1} \cdot {f}_{i} \qquad ( Equation 12 )$$

FIG. 6B shows the input gate. This gate decides which new information should be stored in the cell state. It takes the previous hidden state and current input, processes them through sigmoid and tanh functions, and produces an input vector. The input vector is given by g(t) denoted as Equation 13:

$$g ( t ) = σ ( \vec{{W}_{I}} [ {h}_{t - 1} , {x}_{t} ] ) + tanh ( \vec{{W}_{I}} [ {h}_{t - 1} , {x}_{t} ] ) \qquad ( Equation 13 )$$

This input vector is then combined with the previous cell state to update the current cell state.

FIG. 6C shows the output gate. This gate controls the flow of information from the current cell state to the next hidden state. It takes the previous hidden state and current input, processes them through sigmoid and tanh functions, and produces an output vector. The output vector is then multiplied by the current cell state to obtain the next hidden state. The result from the forget gate is shown in Equation 14:

$${c}_{t} = {c}_{t - 1} \cdot {f}_{i} + g ( t ) \qquad ( Equation 14 )$$

The result from the output gate is given as hₜ denoted as:

$${h}_{t} = σ ( \vec{{W}_{I}} [ {h}_{t - 1} , {x}_{t} ] ) * tanh ( {C}_{t} ) \qquad ( Equation 15 )$$

By using these gates, LSTMs can selectively remember or forget information from previous steps, allowing them to capture long-term dependencies in the data. The cell state acts as a “highway” for information flow, while the hidden state carries the relevant information to the next step.

### XGBoost Regression

XGBoost regression works by iteratively adding decision trees to a regression model while minimizing a specific loss function (e.g., mean squared error) through gradient descent. Each tree is built to correct the errors made by the previous trees, with the final prediction being the sum of the predictions from all the trees. Formally, let y; (+) be the prediction of the i-th instance at the t-th iteration, fₜ is added to minimize the following objective:

$${L}^{( t )} = {\sum }_{i = 1}^{n} l ( {y}_{i} , {\hat{y}}_{i}^{( t - 1 )} + {f}_{t} ( {X}_{i} ) ) + Ω ( {f}_{t} ) \qquad ( Equation 16 )$$

XGBoost is described by Chen, T. and Guestrin, C. (“Xgboost: A scalable tree boosting system.” Proceedings of the 22nd acm sigkdd international conference on knowledge discovery and data mining. 2016.), which is incorporated by reference herein in its entirety.

### Autoregressive Integrated Moving Average

In some embodiments, ARIMA is used to process state data to predict future state data. Example techniques for processing time series data using ARIMA are described by Wagner, B. and Cleland, K. (“Using autoregressive integrated moving average models for time series analysis of observational data.” bmj 383 (2023).), which is incorporated by reference herein in its entirety.

### Example Waste Prediction Techniques

As described herein, in some embodiments, future waste is predicted for one or more system(s) and/or one or more component(s) of the one or more system(s) given future state data (e.g., future state data 115 shown in FIG. 1A) for the system(s) and/or component(s). For example, future waste may be predicted at the system level given future state that indicates predicted value(s) for one or more inputs and/or outputs of the system. Future waste may be predicted at the component level given future state data that indicates predicted value(s) for one or more inputs and/or outputs of the particular component. Example techniques for predicting waste given input(s) and/or output(s) of one or more system(s) are described in U.S. patent application Ser. No. 18/632,683, entitled “MACHINE LEARNING OPTIMIZATION OF A PROCESS IN VIEW OF PREDICTED SUSTAINABILITY” and U.S. patent application Ser. No. 18/632,948, entitled “MACHINE LEARNING OPTIMIZATION OF MULTIPLE PROCESSES IN VIEW OF PREDICTED SUSTAINABILITY,” each of which is incorporated by reference herein in its entirety.

Let \vec{y}=[y₁, y₂, y₃ . . . yₖ], where y₁-yₖ represent different wastes, e.g., y₁ represents carbon emission, y₂ represents methane, y₃ represents hydrogen, and yₖ represents other high substances.

$${y}_{i} = {W}^{T} \cdot X ; {y}_{1} ∈ {R}^{1 * n} ; X ∈ {R}^{m * n} \qquad ( Equation 17 )$$

where W is a weight vector, X is the future state data for the component(s) or system(s), and n is the number of features in each time series included in X, and m is the number of time series in X.

Mean squared error may be used as the loss function. Equation 18 shows the loss function for a first waste item:

$$L ( W ) = {f}_{1} ( X ) = \frac{1}{N} * ( Y - {W}^{T} \cdot X ) {( Y - {W}^{T} \cdot X )}^{T} \qquad ( Equation 18 )$$

where Y=[Y₁, Y₂, Y₂ . . . . Yₘ].

Cascading to k waste items, Equation 19 is extrapolated:

$$J = [ \begin{matrix}{∇}_{w} ( {f}_{1} X ) ) \\ {∇}_{w} ( {f}_{2} ( X ) ) \\ {∇}_{w} f {(}_{k} ( X ) )\end{matrix} ] = [ \begin{matrix}\frac{\partial ( {f}_{1} ( X ) )}{\partial {w}_{1}} & … & \frac{\partial ( {f}_{1} ( X )}{\partial {w}_{n}} \\ ⋮ & ⋱ & ⋮ \\ \frac{\partial ( {f}_{m} ( X ) )}{\partial {w}_{1}} & … & \frac{\partial ( {f}_{m} ( X ) )}{\partial {w}_{n}}\end{matrix} ] \qquad ( Equation 19 )$$

Interpolating above for one function f₁, Equation 20 is obtained:

$${∇}_{w} f ( W ) = {X}_{train}^{T} \cdot XW - {X}_{train}^{T} \cdot Y \qquad ( Equation 20 )$$

$$where$$

$${X}_{train}^{T}$$

represents time series included in training data (e.g., training data 112 shown in FIGS. 1A-1B), and where W is weight vector, WϵR^{D}. Gradient descent is used to arrive at the weight vector W as:

$$WHILE : {∇}_{w} f ( W ) > Threshold \qquad ( Equation 21 )$$

$$W = W - α ( {X}_{train}^{T} \cdot XW - {X}_{train}^{T} \cdot Y )$$

Thus, given the predicted future state data X, it is possible to solve for the waste component Y.

### Example System Optimization Techniques

As described herein, in some embodiments, one or more values may be updated for one or more inputs to one or more systems and/or one or more inputs to particular component(s) or system(s) included in the one or more systems. For example, the input values may be updated for component(s) and/or system(s) identified as being outliers (e.g., according to the techniques described in the section entitled “Example Outlier Identification Techniques.” In some embodiments, the input values are updated to reduce waste generated the component(s). In some embodiments, the input values are updated to increase an amount and/or quality of one or more outputs of the component(s) and/or system(s). Example techniques for updating input values for system(s) and/or component(s) are described in U.S. patent application Ser. No. 18/632,683, entitled “MACHINE LEARNING OPTIMIZATION OF A PROCESS IN VIEW OF PREDICTED SUSTAINABILITY” and U.S. patent application Ser. No. 18/632,948, entitled “MACHINE LEARNING OPTIMIZATION OF MULTIPLE PROCESSES IN VIEW OF PREDICTED SUSTAINABILITY,” each of which is incorporated by reference herein in its entirety.

For example, in some embodiments, determining updated input value(s) include minimizing a multi-objective waste function using a deterministic optimization process. The deterministic optimization process may find optimum values of input and applied inputs given the constraints, e.g., range of output minimum value per input or applied input and other system constraints.

### Example Outlier Identification Techniques

As described herein, including at least with respect to acts 121 and 122 of illustrative technique 100, shown in FIG. 1A, some embodiments of the technology described herein relate to identifying outliers within system(s). Identifying the outlier(s) may help to determine which input(s) of the system(s) should be updated. For example, the input(s) to one or more outlier components or systems may be updated using the system optimization techniques described herein including at least in the section entitled “Example System Optimization Techniques.”

In some embodiments, identifying the outliers includes representing the one or more systems and their respective components as a graph, denoted as G(V,E) that includes node(s) (V) corresponding to respective component(s) or system(s) of the one or more systems, and edges (E) that signify the strength of connection between the nodes. For example, where the sole output of node i is provided as the sole input to node j, the edge linking nodes i and j may be assigned a value of 1. However, in embodiments where multiple outputs of one node are provided as inputs to one or more other nodes, the strength or weight of the edge may be relevant to the graph representation.

Equation 22 may be used to determine the strength or weight assigned to an edge:

$${w}_{i j} = \frac{{\sum }_{0}^{k} ( n ( {a}_{i} ) ∩ n ( {a}_{k} ) )}{{\sum }_{0}^{k} n ( {a}_{k} )} \qquad ( Equation 22 )$$

where n represents the number of edges connecting the node ai:

$$Network = A ( G ) = ⌈ \begin{matrix}{a}_{11} & {a}_{12} & {a}_{13} & {a}_{14} & {a}_{15} & {a}_{1 m} \\ {a}_{21} & {a}_{22} & {a}_{23} & {a}_{24} & {a}_{25} & {a}_{2 m} \\ {a}_{n 1} & {a}_{n 2} & {a}_{n 3} & {a}_{n 4} & {a}_{n 5} & {a}_{nm}\end{matrix} ⌉ \qquad ( Equation 23 )$$

$$D ( G ) = ⌈ \begin{matrix}{d}_{11} & {d}_{12} & {d}_{13} & {d}_{14} & {d}_{15} & {d}_{1 m} \\ {d}_{21} & {d}_{22} & {d}_{23} & {d}_{24} & {d}_{25} & {d}_{2 m} \\ {d}_{n 1} & {d}_{n 2} & {d}_{n 3} & {d}_{n 4} & {d}_{n 5} & {d}_{nm}\end{matrix} ⌉ \qquad ( Equation 24 )$$

where d represents the degree of connectedness between i and j.

Equation 25 can be rewritten as row vectors with each row vector representing linkage to other components or systems. Let each row vector be called A₁, A₂ . . . . Am, respectively:

$$A ( G ) = [ \begin{matrix}{A}_{1} \\ {A}_{2} \\ … \\ {A}_{m}\end{matrix} ] \qquad ( Equation 25 )$$

The vector of the graph provides an understanding of the relevant linkages between different abstract components or systems.

In some embodiments, the size and/or a value attributed to a node in the graph is indicative of the future waste predicted for the component or system that the node represents. Example techniques for predicting future waste are described herein including at least with respect to act 116 shown in FIG. 1A and in the section entitled “Example Waste Prediction Techniques.”

In some embodiments, the techniques include determining, for each of at least some (e.g., all) of the nodes, whether the node should be indicated as an outlier. This may involve evaluating the state data obtained for the particular component or system represented by the node. For example, the state data may include a respective time series \vec{X} for each input and/or output of the particular component or system represented by the node. Determining whether the node is an outlier may involve determining:

$${outlier}_{flag} = \{ \begin{matrix}1 if \vec{( X )} - μ ) > σ ⋆ 2.5 \\ 0 if \vec{( X )} - μ ) < σ ⋆ 2.5\end{matrix} \qquad ( Equation 26 )$$

where μ is the mean of time series \vec{X} and σ is the standard deviation of time series \vec{X}.

In some embodiments, when node(s) are identified as outlier(s) using Equation 26, then value(s) of one or more of the input(s) to the component or system represented by the node(s) are updated using the techniques described herein including at least with respect to act 123 shown in FIG. 1A and in the section entitled “Example System Optimization Techniques.”

In some embodiments, when multiple nodes are identified as outliers, then the waste function of the outlier nodes may be updated. For example, the waste function of the outlier nodes may be updated when the ratio of the number of outlier nodes to the total number of nodes in the graph is greater than 0.5.

In some embodiments, determining the updated waste function involves using measures of network:

$$NIV = ( \begin{matrix}{C}_{d} ( {n}_{i} ) \\ {C}_{c} ( {n}_{i} )\end{matrix} ) \qquad ( Equation 27 )$$

$$where :$$

$${C}_{d} ( {n}_{i} ) = d ( {n}_{i} ) d - degree of {n}_{i} \qquad ( Equation 28 )$$

$$And$$

$${C}_{c} ( {n}_{i} ) = Node In - between = {\sum }_{j < k} \frac{{g}_{j , k} ( {n}_{i} )}{{g}_{j , k}} \qquad ( Equation 29 )$$

where g_{j,k} is the shortest paths between i and k containing nᵢ, and the “degree” of a node is defined as the number of direct connections a node has with other nodes.

Hence, each node gets assigned to a vector value based on centrality statistics of network. The overall waste function of a node will be given by:

$$H ( i ) = {y}_{i} * {z}_{i} . \qquad ( Equation 30 )$$

where zᵢ=L2 NORM (NIV).

### Identifying Sub-Graphs Within Graph Representing System(s)

Modularity is a measure of the structure of networks or graphs which measures the strength of division of a graph into modules (also called groups, clusters or communities). Graphs with high modularity have dense connections between the nodes within modules but sparse connections between nodes in different modules.

The modularity (Q) is calculated by comparing the fraction of edges within modules to the fraction that would be expected in a random network with the same node degrees.

$$Q ∝ {\sum }_{s ∈ S} \# {a}_{ij} group s ) - ( expected \# edges within groups ) ) \qquad ( Equation 31 )$$

$$Q ( G , S ) = \frac{1}{2 m} {\sum }_{s ∈ S} {\sum }_{i ∈ s} {\sum }_{j ∈ s} ( {A}_{i j} - \frac{{k}_{i} {k}_{j}}{2 m} ) , {A}_{i} j = 1 if connected , else 0 \qquad ( Equation 32 )$$

In some embodiments, the Girvan-Newman algorithm can be used to identify modules in complex graphs. The Girvan-Newman algorithm is described by Newman, M. and Girvan, M. (“Finding and evaluating community structure in networks.” Physical review E 69.2 (2004): 026113.), which is incorporated by reference herein in its entirety.

In some embodiments, spectral clustering can be used to identify modules in complex graphs. In some embodiments, spectral clustering may be performed by computing similarity scores between nodes by passing the graph through a Gaussian Kernel. The Gaussian similarity measure considers the distances between data points, and even if the weights between edges are 1, the distances can still be calculated and used to determine the similarity between the data points for clustering.

For example, let matrix A (G) represent the graph with vertices V and edges E, with aᵢⱼ=1 if i and j are connected, else 0. The degree D (G) is calculated as given in Equation 24. Given a system may have multiple components or systems, a weight matrix can be calculated as W. The Gaussian Kernel can be passed to create a shared matrix with a sigma value.

A weighted adjacency matrix of a simple graph is defined for a real positive symmetric function on the vertex degrees of a graph as function. The input of degrees can be used in x[i],x[j] to compute sᵢⱼ to create similarity matrix S:

$${s}_{i j} = \frac{1}{2 {σ}^{2}} e {‖ {x}_{i} - {x}_{j} ‖}^{2} \qquad ( Equation 33 )$$

The Laplacian matrix is the difference between the degree and adjacency matrices, and eigen vectors can be used to create to describe graphical property of graph. Hence spectral clustering can help in identifying subgraphs with modules within complex machine systems by associating cluster to lowest eigen values.

In some embodiments, the value(s) or one or more input(s) to the identified module(s) (e.g., the components or systems included in the identified module(s)) are updated. For example, the input value(s) may be updated according to the techniques described herein including at least with respect to act 123 shown in FIG. 1A and in the section entitled “Example System Optimization Techniques.”

### EXAMPLES

The examples described herein relate to managing waste for one or more example systems. It should be appreciated, however, that the techniques may be applied to any other suitable types of systems, as aspects of the technology described herein are not limited in this respect.

### Nickel and Copper Mining Flotation System

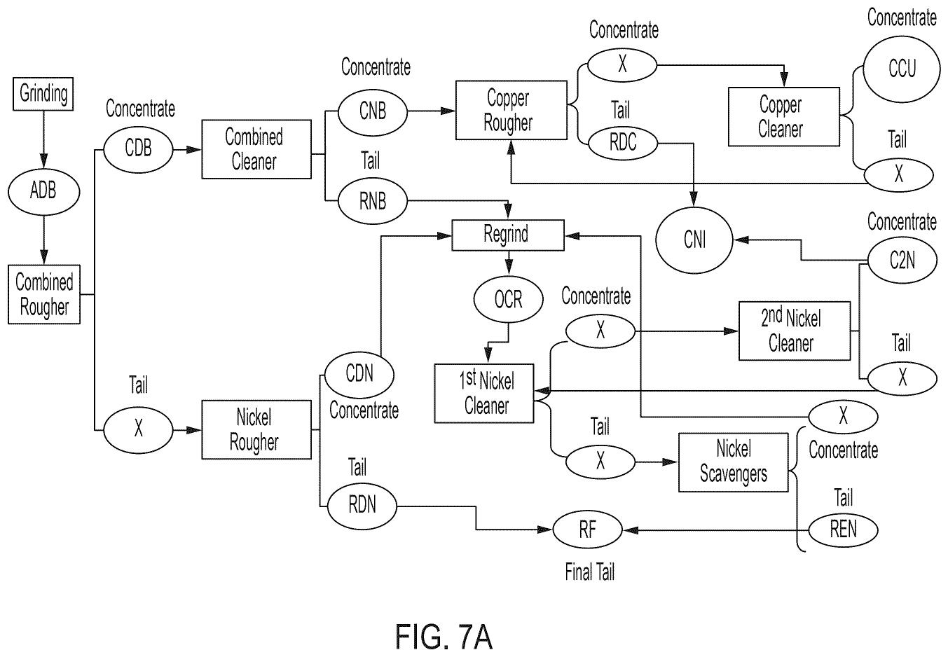

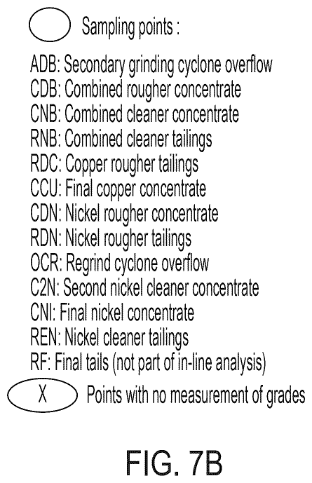

FIG. 7A and FIG. 7B show a diagram of an example nickel and copper mining flotation system. In the example, different “components” of the system are referred to as “stages.” The flotation process involves multiple stages to efficiently recover copper and nickel from ore. It begins with the Combined Rougher stage, which aims to recover over 90% of copper and over 75% of nickel while minimizing gangue in the tails sent to the Nickel Roughers. Different percentages of reagents (such as Xanthate, pH modifiers, SMBS/DETA, CMC, and MIBC) and air flows are adjusted at each stage to optimize separation. Next, the Nickel Roughers scavenge slower floating particles from the combined rougher tails, with their concentrate feeding into the regrind mill while most of the tails form the final waste. The Combined Cleaners then prepare the concentrate for separation by removing gangue, sending the concentrate to the Copper Rougher stage, which operates at a high pH to depress nickel-bearing minerals. The copper concentrate is further refined in the Copper Cleaner, which utilizes columns to ensure that any unwanted pentlandite is returned to the copper rougher. Finally, the Nickel Cleaner operates on a counter-current principle to further refine the nickel concentrate, processing the output from the regrind and ensuring that any unrecovered particles are sent to the final tails.

Inputs to the system include ore, flow rates, temperature, pressure, types and quantities of reagents used (e.g., Xanthates, CMC, MIBC, PH Regulators, etc.), energy for powering the flotation circuit, and water. At least some of the inputs (e.g., flow rates, pressure, temperature, etc.) may be measured using one or more sensors.

In some embodiments, the outputs of the nickel and copper mining flotation system include nickel and copper, including the recovery rates and grades thereof.

Waste generated by the system may include emissions (e.g., CO2, other greenhouse gases, etc.) and tailings.

In some embodiments, the techniques described herein are used to predict future recovery rates and grades for nickel and copper. The predicted future recovery rates and grades may then be used to estimate emissions and tailings generated by the system (i.e., future waste). The future waste may be compared to a pre-determined target waste (e.g., a target amount of tailings and/or emissions) to determine at least one degree of variance between the future and target waste and optionally a confidence therein.

In some embodiments, if the degree(s) of variance and (optionally) confidence indicate that the future waste is likely to vary from the intended target waste, then one or more of the input values may be updated to reduce this variance. For example, this may include increasing or decreasing the temperature, pressure, air flow rates, the amount of water used, and/or the amount(s) of different types of reagents used.

### Water Desalination System

The techniques described herein may additionally or alternatively be applied to a water desalination system. The water desalination system may include two systems: (1) a pre-treatment system that processes source water (e.g., seawater) to remove large particles organic matter, and other impurities from the water to protect the desalination equipment, and (2) a desalination system that processes water from the pre-treatment system by forcing it through reverse osmosis that allows water molecules to pass, but blocks salts and other impurities. The pre-treatment system may include multiple components including: filtration, sedimentation, and chemical treatment.

Inputs to the water desalination system may include source water (e.g., seawater) including the salinity levels of the source water, total dissolved salts in the source water, temperature of the source water, variations in the salinity in the source water, and/or presence of contaminants in the source water (e.g., biological, chemical contaminants). Additionally or alternatively, the inputs may include flow rates of source water intake, pressure levels in the desalination system equipment, energy consumption by pumps and/or membranes, the amounts and types of antiscalants and other chemicals used by the pre-treatment system, and/or climatic factors.

The outputs of the water desalination system may include freshwater, including the volume of freshwater produced and the concentration of salts and contaminants in the output water.

Waste generated by the water desalination system may include energy consumption per unit of water produced, emissions associated with the energy usage, and/or an amount and/or concentration of brine produced.

In some embodiments, the techniques described herein are used to predict future input(s) and/or output(s) of the water desalination system such as future pressure, flow rates, etc. The predicted future state data may then be used to estimate energy consumption, emissions and brine generated by the system (i.e., future waste). The future waste may be compared to a pre-determined target waste (e.g., a target amount of brine, energy consumption, emissions, etc.) to determine at least one degree of variance between the future and target waste and optionally a confidence therein.

In some embodiments, if the degree(s) of variance and (optionally) confidence indicate that the future waste is likely to vary from the intended target waste, then one or more of the input values may be updated to reduce this variance. For example, this may include adjusting the temperature, flow rates, pressure levels, and/or amounts or type of chemicals and antiscalants.

### Butter Churning System

The techniques described herein may additionally or alternatively be applied to a butter churning system.

The inputs to the butter churning system may include cream, temperature, churn speed, churn time, and/or energy consumption.

The outputs of the butter churning system may include butter and buttermilk, including the moisture content and fat-free dry matter (FFDM) of the output butter and/or buttermilk. The butter must have a moisture content and FFDM within specific ranges to be classified as high quality. Fat-Free Dry Matter (FFDM) refers to the portion of a dairy product that remains after all the fat and water have been removed. In the context of butter churning, FFDM is important because it helps determine the quality and yield of the butter produced. It represents the non-fat components, such as proteins, carbohydrates, and minerals, which contribute to the texture and flavor of the butter.

During processing, cream is churned at controlled temperatures and speeds to emulsify fats and separate butter from buttermilk.

Waste generated by the butter churning system may include an amount of butter and/or buttermilk that does not have a moisture content and/or FFDM within the specified ranges, energy consumption, and/or emissions associated with energy consumption.

In some embodiments, the techniques described herein are used to predict future input(s) and/or output(s) of the butter churning system such as future temperature, churn speed, and/or energy consumption. The predicted future temperature, churn speed, and/or energy consumption may be used to estimate emissions and/or amount(s) of unusable butter and/or buttermilk generated by the system (i.e., future waste). The future waste may be compared to a pre-determined target waste (e.g., a target amount of emissions, unusable butter, etc.) to determine at least one degree of variance between the future and target waste and optionally a confidence therein.

In some embodiments, if the degree(s) of variance and (optionally) confidence indicate that the future waste is likely to vary from the intended target waste, then one or more of the input values may be updated to reduce this variance. For example, this may include adjusting the temperature, churn speed, churn time, and/or energy usage.

### Computer Implementation

An illustrative implementation of a computer system 800 that may be used in connection with any of the embodiments of the technology described herein (e.g., such as process 400 shown in FIG. 4) is shown in FIG. 8. The computer system 800 includes one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage media 830 in any suitable manner, as the aspects of the technology described herein are not limited to any particular techniques for writing or reading data. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

Computing system 800 may include a network input/output (I/O) interface 840 via which the computing device may communicate with other computing devices. Such computing devices may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Computing system 800 may also include one or more user I/O interfaces 850, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

Further, it should be appreciated that a computer may be embodied in any of a number of forms, such as a rack-mounted computer, a desktop computer, a laptop computer, or a tablet computer, as examples. Additionally, a computer may be embedded in a device not generally regarded as a computer but with suitable processing capabilities, including a Personal Digital Assistant (PDA), a smartphone, a tablet, or any other suitable portable or fixed electronic device. The above-described embodiments can be implemented in any of numerous ways. For example, the embodiments may be implemented using hardware, software, or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

The foregoing description of implementations provides illustration and description but is not intended to be exhaustive or to limit the implementations to the precise form disclosed. Modifications and variations are possible in light of the above teachings or may be acquired from practice of the implementations. In other implementations the methods depicted in these figures may include fewer operations, different operations, differently ordered operations, and/or additional operations. Further, non-dependent blocks may be performed in parallel.

It will be apparent that example aspects, as described above, may be implemented in many different forms of software, firmware, and hardware in the implementations illustrated in the figures.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as an example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as an example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately,” “substantially,” and “about” may be used to mean within +20% of a target value in some embodiments, within +10% of a target value in some embodiments, within +5% of a target value in some embodiments, within +2% of a target value in some embodiments. The terms “approximately,” “substantially,” and “about” may include the target value.

What is claimed is:

1. A method for managing waste associated with one or more systems used to process one or more inputs to obtain one or more outputs, the method comprising:
using at least one processor to perform:
obtaining state data for the one or more systems, the state data indicating: (i) a first set of time series for the one or more inputs and (ii) a second set of time series for the one or more outputs;
configuring a forecasting engine to predict future state data for the one or more systems, the configuring comprising:
selecting at least one forecasting model based on (i) a number of the one or more systems and/or (ii) one or more characteristics of the state data;
processing the state data using the configured forecasting engine to predict the future state data for the one or more systems, the future state data indicating: (i) one or more predicted input values for the one or more inputs, and (ii) one or more predicted output values for the one or more outputs;
determining, using at least some of the future state data, one or more values indicative of future waste associated with the one or more systems;
determining (i) at least one degree of variance between the one or more values indicative of the future waste and one or more values indicative of a target waste specified for the one or more systems, and (ii) a respective confidence associated with the at least one degree of variance; and
outputting a report indicating the at least one degree of variance and the respective confidence associated with the at least one degree of variance.

2. The method of claim 1, further comprising determining, using the at least one degree of variance, the respective confidence associated with the at least one degree of variance, and/or the future state data, one or more updated values for the one or more inputs.

3. The method of claim 2, further comprising outputting a recommendation to use the one or more updated values for the one or more inputs.

4. The method of claim 2, further comprising applying the one or more updated values to the one or more inputs and processing the one or more inputs using the one or more systems.

5. The method of claim 2, wherein determining, using the at least one degree of variance and the future state data, the one or more updated values for the one or more inputs comprises:
determining whether the at least one degree of variance is greater than or equal to a threshold variance; and
after determining that the at least one degree of variance is greater than or equal to the threshold variance, determining the one or more updated values using the future state data.

6. The method of claim 1, wherein selecting the at least one forecasting model comprises selecting the at least one forecasting model from among:
at least one multivariate forecasting model,
at least one univariate forecasting model, and
dynamic mode decomposition.

7. The method of claim 6, wherein selecting the at least one forecasting model based on the number of the one or more systems comprises selecting dynamic mode decomposition when the number of the one or more systems is greater than one.

8. The method of claim 6, wherein selecting the at least one forecasting model based on the number of the one or more systems comprises selecting the at least one multivariate forecasting model or the at least one univariate forecasting model when the number of the one or more systems is equal to one.

9. The method of claim 8, wherein configuring the forecasting engine further comprises:
obtaining training data for the one or more systems; and
processing the training data using temporal clustering to identify one or more characteristics of the training data,
wherein selecting the at least one forecasting model based on the one or more characteristics of the state data comprises:
selecting at least one multivariate forecasting model, from among a plurality of multivariate forecasting models, based on the one or more characteristics of the training data.

10. The method of claim 9, wherein the plurality of multivariate forecasting models comprises a vector autoregressive (VAR) model, a recurrent neural network (RNN) model, decision tree model, and an autoregressive moving average (ARMA) model.

11. The method of claim 9, wherein processing the training data using temporal clustering comprises processing the training data using Euclidean distance temporal clustering, shape-based temporal clustering, or dynamic time warping.

12. The method of claim 9, wherein the one or more characteristics of the training data comprise a degree of correlation among time series, a non-linear relationship among the time series, an amount of data in the time series, and/or a degree of noise present in the time series.

13. The method of claim 1, wherein configuring the forecasting engine further comprises:
obtaining training data for the one or more systems; and
identifying one or more characteristics of the training data,
wherein selecting the at least one forecasting model based on the one or more characteristics of the state data comprises:
selecting at least one univariate forecasting model, using the one or more characteristics of the training data, from among a vector autoregressive (VAR) model, a recurrent neural network (RNN) model, and an autoregressive moving average model (ARMA).

14. The method of claim 1, wherein obtaining the state data comprises obtaining at least some of the first set of time series and/or at least some of the second set of time series using one or more sensors.

15. The method of claim 1, further comprising:
representing the one or more systems as a graph comprising nodes and edges, wherein a node represents a system or a component of the system, and wherein the edges represents connections between the nodes;
dividing the graph into a plurality of sub-graphs; and
identifying, using the at least one degree of variance, one or more of the plurality of sub-graphs associated with a degree of variance that is greater than or equal to a threshold.

16. The method of claim 1, wherein:
the one or more systems comprise a nickel and mining flotation system,
the one or more inputs comprise energy consumption, water consumption, a respective type of one or more reagents, and/or a respective amount of the one or more reagents,
the one or more outputs comprise a grade of recovered nickel, a grade of recovered copper, emissions data, and/or an amount of tailings, and
the method further comprises:
outputting a recommendation to update the respective type of the one or more reagents and/or the respective amount of the one or more reagents.

17. The method of claim 1, wherein:
the one or more systems comprise a water desalination system,
the one or more inputs comprise a salinity level of source water, total dissolved solids in the source water, presence of contaminants in the source water, a flow rate of source water intake, one or more pressure levels in the water desalination system, energy consumption by one or more pumps and/or membranes, an amount of one or more antiscalants, a type of one or more antiscalants, a type of one or more chemicals, temperature of the source water, salinity variations of the source water, one or more seasonal factors, one or more energy sources, and/or one or more climatic factors,
the one or more outputs comprise a volume of freshwater produced and/or a concentration of salts and contaminants in the freshwater produced, and
the method further comprises:
outputting a recommendation to update the flow rate of the source water intake, the one or more pressure levels, and/or the energy consumption by the one or more pumps and/or membranes.

18. The method of claim 1, wherein:
the one or more systems comprise a butter churning system,
the one or more inputs comprise an amount of cream, a temperature, a churn speed, a churn time, and/or energy consumption,
the one or more outputs comprise an amount of butter, an amount of buttermilk, an amount of waste byproducts, moisture content of the butter, and/or a fat-free dry matter of the butter, and
the method further comprises:
outputting a recommendation to update the churn time, the churn speed, the temperature, and/or the energy consumption.

19. A system comprising:
at least one processor; and
at least one non-transitory computer-readable storage medium storing processor-executable instructions that, when executed by the at least one processor, cause the at least one processor to perform a method for managing waste associated with one or more systems used to process one or more inputs to obtain one or more outputs, the method comprising:
obtaining state data for the one or more systems, the state data indicating: (i) a first set of time series for the one or more inputs and (ii) a second set of time series for the one or more outputs;
configuring a forecasting engine to predict future state data for the one or more systems, the configuring comprising:
selecting at least one forecasting model based on (i) a number of the one or more systems and/or (ii) one or more characteristics of the state data;
processing the state data using the configured forecasting engine to predict the future state data for the one or more systems, the future state data indicating: (i) one or more predicted input values for the one or more inputs, and (ii) one or more predicted output values for the one or more outputs;
determining, using at least some of the future state data, one or more values indicative of future waste associated with the one or more systems;
determining (i) at least one degree of variance between the one or more values indicative of the future waste and one or more values indicative of a target waste specified for the one or more systems, and (ii) a respective confidence associated with the at least one degree of variance; and
outputting a report indicating the at least one degree of variance and the respective confidence associated with the at least one degree of variance.

20. At least one non-transitory computer-readable storage medium storing processor-executable instructions that, when executed by at least one processor, cause the at least one processor to perform method for managing waste associated with one or more systems used to process one or more inputs to obtain one or more outputs, the method comprising:
obtaining state data for the one or more systems, the state data indicating: (i) a first set of time series for the one or more inputs and (ii) a second set of time series for the one or more outputs;
configuring a forecasting engine to predict future state data for the one or more systems, the configuring comprising:
selecting at least one forecasting model based on (i) a number of the one or more systems and/or (ii) one or more characteristics of the state data;
processing the state data using the configured forecasting engine to predict the future state data for the one or more systems, the future state data indicating: (i) one or more predicted input values for the one or more inputs, and (ii) one or more predicted output values for the one or more outputs;
determining, using at least some of the future state data, one or more values indicative of future waste associated with the one or more systems;
determining (i) at least one degree of variance between the one or more values indicative of the future waste and one or more values indicative of a target waste specified for the one or more systems, and (ii) a respective confidence associated with the at least one degree of variance; and
outputting a report indicating the at least one degree of variance and the respective confidence associated with the at least one degree of variance.
